(19) United States
(12) Patent Application Publication
(10) Pub. No.: US 2025/0225968 A1
(43) Pub. Date: Jul. 10, 2025

(54) INFORMATION PROCESSING DEVICE, INFORMATION PROCESSING METHOD, INFORMATION PROCESSING PROGRAM, AND INFORMATION PROCESSING SYSTEM

(71) Applicant: SONY GROUP CORPORATION, TOKYO (JP)

(72) Inventors: RINA KOTANI, TOKYO (JP); SHIRO SUZUKI, TOKYO (JP)

(21) Appl. No.: 18/848,845

(22) PCT Filed: Mar. 20, 2023
(86) PCT No.: PCT/JP2023/010787

§ 371 Date: Sep. 19, 2024

(30) Foreign Application Priority Data
Mar. 31, 2022 (JP) 2022-058944

(51) Int. Cl. G10K 11/175

(52) U.S. Cl. CPC G10K 11/1754

(57) ABSTRACT

An information processing device (100) of the present disclosure includes a signal duplication unit (152), a band division unit (153), a signal inversion unit (154), a signal addition unit (155), a buffer unit (156), and a signal transmission unit (157). A signal duplication unit (152) duplicates target sound set as a processing target. A band division unit (153) divides a band of the target sound into an inversion frequency band set as a target of phase inversion processing and a non-inversion frequency band not set as a target of the phase inversion processing. A signal inversion unit (154) generates an inverted signal obtained by inverting a phase of a first sound signal corresponding to the inversion frequency band. A signal addition unit (155) generates an addition signal obtained by adding up the inverted signal and a second sound signal corresponding to the non-inversion frequency band. The buffer unit (156) temporarily stores an original sound signal of the target sound before processing. The signal transmission unit (157) transmits the addition signal and the original sound signal stored in the buffer unit to external equipment while synchronizing the addition signal and the original sound signal.

### FIELD

The present disclosure relates to an information processing device, an information processing method, an information processing program, and an information processing system.

### BACKGROUND

There have been proposed various techniques for enhancing, with signal processing to which a binaural masking level difference (BMLD), which is one of human auditory psychological phenomena, is applied, voice desired to be listened to.

For example, Patent Literature 1 proposes a hearing aid system that increases a perceptual sound pressure level by estimating target sound from external sound and separating the target sound from environmental noise to be set to opposite phases between both the ears.

Patent Literature 2 proposes a system that reproduces environmental noise having a sound pressure level corresponding to a listener position in order to prevent a part of listeners from hearing received voice in a vehicle.

### CITATION LIST

### Patent Literature

Patent Literature 1: JP 2015-39208 A
Patent Literature 2: JP 2014-176052 A

### SUMMARY

### Technical Problem

However, in the related art, as a result of performing the signal processing to which the binaural masking level difference is applied, a problem could occur in which sound subjected to phase inversion processing is heard floating and unnatural audibility is given to the listener.

Therefore, the present disclosure proposes an information processing device, an information processing method, an information processing program, and an information processing system capable of giving a natural audibility to a listener in signal processing to which a binaural masking level difference is applied.

### Solution to Problem

To solve the above problem, an information processing device that provides a service that requires an identity verification process according to an embodiment of the present disclosure includes: an information processing device comprising: a signal duplication unit that duplicates a sound signal of target sound set as a processing target; a band division unit that divides a band of the target sound into an inversion frequency band set as a target of phase inversion processing and a non-inversion frequency band not set as a target of the phase inversion processing; a signal inversion unit that generates an inverted signal obtained by inverting a phase of a first sound signal corresponding to the inversion frequency band; a signal addition unit that generates an addition signal obtained by adding up the inverted signal and a second sound signal corresponding to the non-inversion frequency band; a buffer unit that temporarily stores an original sound signal of the target sound before processing; and a signal transmission unit that transmits the addition signal and the original sound signal stored in the buffer unit to external equipment while synchronizing the addition signal and the original sound signal.

### BRIEF DESCRIPTION OF DRAWINGS

FIG. 1 is a diagram for explaining an overview of a BMLD.

FIG. 2 is a diagram illustrating an example of frequency characteristics of the BMLD.

FIG. 3 is a diagram illustrating an example of a signal processing method according to a comparative example.

FIG. 4 is a diagram illustrating an example of a signal processing method according to an embodiment of the present disclosure.

FIG. 5 is a diagram illustrating a configuration example of an information processing system according to a first embodiment of the present disclosure.

FIG. 6 is a block diagram illustrating a device configuration example of devices included in the information processing system according to the first embodiment of the present disclosure.

FIG. 7 is a diagram illustrating an example of a user interface according to the first embodiment of the present disclosure.

FIG. 8 is a diagram for explaining a specific example of units of a reproduction device according to the first embodiment of the present disclosure.

FIG. 9 is a diagram for explaining a specific example of the units of the reproduction device according to the first embodiment of the present disclosure.

FIG. 10 is a diagram for explaining a modification of the units of the reproduction device according to the first embodiment of the present disclosure.

FIG. 11 is a flowchart illustrating an example of a processing procedure (part 1) of the signal processing method according to the first embodiment of the present disclosure.

FIG. 12 is a flowchart illustrating an example of a processing procedure (part 2) of the signal processing method according to the first embodiment of the present disclosure.

FIG. 13 is a diagram illustrating a configuration example of an information processing system according to a second embodiment of the present disclosure.

FIG. 14 is a block diagram illustrating a device configuration example of devices included in an information processing system according to the second embodiment of the present disclosure.

FIG. 15 is a diagram for explaining a specific example of units of an information processing device according to the second embodiment of the present disclosure.

FIG. 16 is a diagram for explaining a specific example of the units of the information processing device according to the second embodiment of the present disclosure.

FIG. 17 is a flowchart illustrating an example of a processing procedure (part 1) of a reproduction device according to a modification of the present disclosure.

FIG. 18 is a flowchart illustrating an example of a processing procedure (part 2) of the reproduction device according to a modification of the present disclosure.

FIG. 19 is a block diagram illustrating a hardware configuration example of a computer corresponding to the devices according to the embodiments and the modifications of the present disclosure.

### DESCRIPTION OF EMBODIMENTS

Embodiments of the present disclosure are explained in detail below with reference to the drawings. Note that, in the embodiments explained below, redundant explanation of components having substantially the same functional configurations is sometimes omitted by adding the same numbers and signs to the components. In the present specification and the drawings, a plurality of components having substantially the same functional configuration are sometimes distinguished and explained by adding different numbers or signs after the same number or sign.

The explanation of the present disclosure is made according to item order described below.

1. Introduction

2. First Embodiment

2-1. Overview of a signal processing method according to a comparative example

2-2. Overview of a signal processing method according to a first embodiment

2-3. System configuration example

2-4. Device configuration example

2-4-1. Configuration Example of a sound output device

2-4-2. Configuration example of a reproduction device

2-4-3. Specific Example of units of the reproduction device

2-4-4. Modification of the units of the reproduction device

2-5. Processing procedure example

2-5-1. Processing procedure in a frequency domain

2-5-2. Processing procedure in a time domain

3. Second Embodiment

3-1. System configuration example

3-2. Device configuration example

3-2-1. Configuration example of a communication terminal

3-2-2. Configuration example of headphones

3-2-3. Configuration example of an information processing device

3-2-4. Specific Example of units of the information processing device

4. Modifications

4-1. Processing procedure (part 1) in the case in which target sound is a stereo signal

4-2. Processing procedure (part 2) in the case in which the target sound is the stereo signal

5. Others

6. Hardware configuration example

7. Conclusion

### <<1. Introduction>>

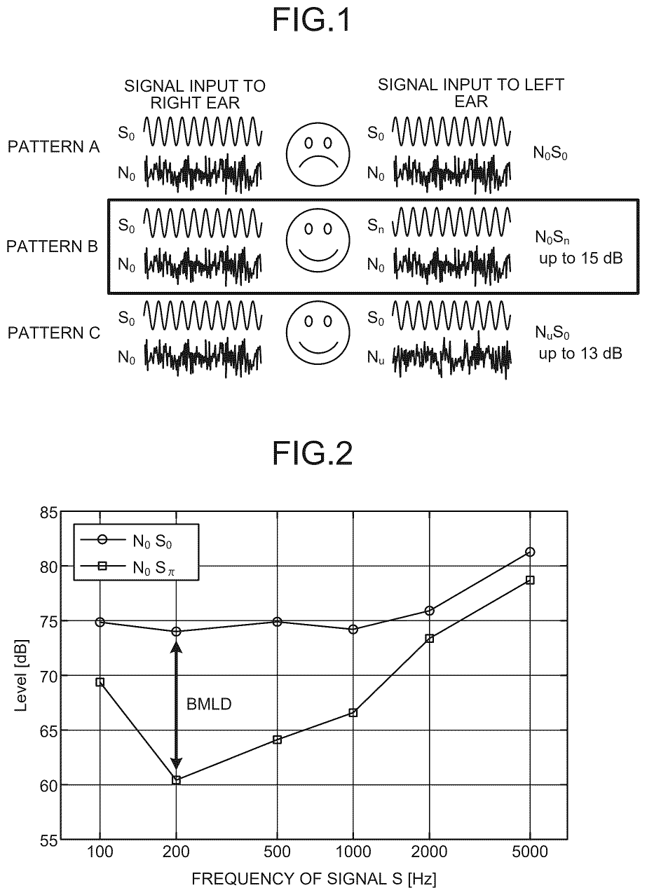

An overview of a binaural masking level difference (hereinafter referred to as “BMLD”), which is one of human auditory psychological phenomena, is explained below with reference to FIG. 1. FIG. 1 is a diagram for explaining an overview of the BMLD. In FIG. 1, “S” indicates a sound signal of target sound, which is sound desired to be listened to, and “N” indicates a sound signal of a masker, which is interference sound that blocks the target sound. “o (S or N)₀” indicates that there is no phase difference between sounds in both the ears (left and right). “o (S or N)^{π}” indicates that the sounds in both the ears (left and right) are in opposite phases to each other. “o (S or N)ᵤ” indicates that there is no correlation between the sounds in both the ears (left and right).

The presence of the masker making it difficult to detect the target sound is referred to as masking. A sound pressure level of the target sound at the time when the masker can barely detect the target sound when the masker sound pressure is constant is referred to as masking threshold. As illustrated in a pattern A and a pattern B in FIG. 1, a difference between a masking threshold at the time when target sound in the same phase is listened to under a masker in the same phase (for example, white noise) and a masking threshold at the time when target sound in opposite phases is listened to between both the ears under the masker in the same phase (the white noise) is the BMLD. The BMLD occurs even if a phase difference of the target sound between both the ears is changed by any value other than 180 degrees (π). However, when the phase difference of the target sound between both the ears is set to 180 degrees (π), the BMLD is maximized and the target sound is more easily listened to. For example, a verification result has been reported in which, when a case in which target sound in opposite phases is listened to between both the ears in the same white noise environment and a case in which target sound in the same phase is listened to between both the ears in the same white noise environment are compared, a psychological volume increase equivalent to 15 dB (decibels) is given to a listener when the target sound is set in the opposite phases between both the ears (Hirsh, I.J. (1948). “The influence of interaural phase on interaural summation and inhibition.” Journal of the Acoustical Society of America, 20, 536-544. Internet URL: https://doi.org/10.1121/1.1906407).

Note that, as illustrated in the pattern A and a pattern C in FIG. 1, the BMLD also occurs in a method in which the target sound between both the ears is kept in the same phase and a masker (for example, white noise) is made uncorrelated between both the ears. For example, in this case, a verification result has been reported in which a psychological volume increase equivalent to 13 dB (decibels) is given to the listener. As explained above, in the BMLD, an effect of making it easy to listen to the target sound in the masker environment is recognized.

Incidentally, when processing of the BMLD has been executed, sound subjected to phase inversion processing sometimes has “ball-like” audibility and is heard floating for the listener to give unnatural audibility. A factor of such audibility is considered to be in a human auditory peripheral organ. Sound coming from the ear is decomposed into frequencies by the cochlear duct in the inner ear. A phase difference of the sound between both the ears is calculated in a processing mechanism called a brain stem, which is an entrance to the brain. At this time, the phase difference of the sound between both the ears is easily perceived particularly in a low frequency band. However, the phase difference of the sound between both the ears is sometimes less easily perceived in a high frequency band.

An object of an information processing device according to an aspect of the present disclosure (hereinafter referred to as “information processing device of the present disclosure”) is to solve a problem in listener's audibility that can occur when the processing of the BMLD has been executed. The information processing device of the present disclosure executes signal processing for phase-inverting only a sound component in a specific frequency band in target sound to thereby solve a problem in listener's audibility that can occur when the processing of the BMLD has been executed.

In the following explanation, a reproduction device is explained as an example of the information processing device of the present disclosure. Examples of the reproduction device include audio reproduction equipment, a communication terminal such as a smartphone, and a personal computer. The reproduction device is not limited to the existing reproduction device if the reproduction device is equipment that reproduces stereo sound and may be a new reproduction device. It is assumed that a sound signal processed by the signal processing method according to the embodiment is listened to using a sound output device such as earphones for stereo reproduction or headphones. A listener wearing the sound output device is simply referred to as “user”.

In the following explanation, a frequency band set as a target of phase inversion processing among frequency bands of target sound is referred to as “inversion frequency band”. A frequency band not set as a target of the phase inversion processing among the frequency bands of the target sound is referred to as a “non-inversion frequency band”. Dividing a frequency of sound in a process of signal processing is referred to as band division. As the inversion frequency band explained above, a unique value corresponding to a user may be determined by, for example, analyzing voice of the user in advance. The inversion frequency band explained above may change from moment to moment according to a frequency distribution of the target sound. A boundary line of an inversion frequency may be sequentially changed according to a noise level. The inversion frequency band may have a band pass characteristic. The target sound is not limited to voice and may be music. In addition, in the inversion frequency band, a frequency distribution of noise may be analyzed at any time and the boundary value of the inversion frequency band of the target sound may be determined according to the frequency distribution of the noise.

It is known that the magnitude of the BMLD has frequency dependence. FIG. 2 is a diagram illustrating an example of frequency characteristics of the BMLD; As illustrated in FIG. 2, when target sound is a sine wave, the BMLD is maximized when a frequency of the target sound is 200 Hz (hertz). As explained above, the inversion frequency band may be determined considering the frequency dependence of the magnitude of the BMLD.

As a usage scene of signal processing executed by the information processing device of the present disclosure, an environment in which noise in a train, a crowd, or the like is assumed (hereinafter referred to as “in a noise environment”) is assumed. Accordingly, in a noise environment, when a sound source (music content, voice content, or the like) stored in advance in the reproduction device is listened via headphones or when a call is made through the reproduction device, an effect of making it easy to listen to target sound such as music, voice, or call voice without discomfort can be expected.

As a usage scene of signal processing executed by the information processing device of the present disclosure, online communication is assumed. Accordingly, when voice (target sound) of a specific person among participants in an online meeting or the like using online communication tools overlaps with voice of other participants or noise, an effect of making it easy to listen to the voice of the specific one person without discomfort can be expected.

### 2. First Embodiment

### <2-1. Overview of a Signal Processing Method According to a Comparative Example>

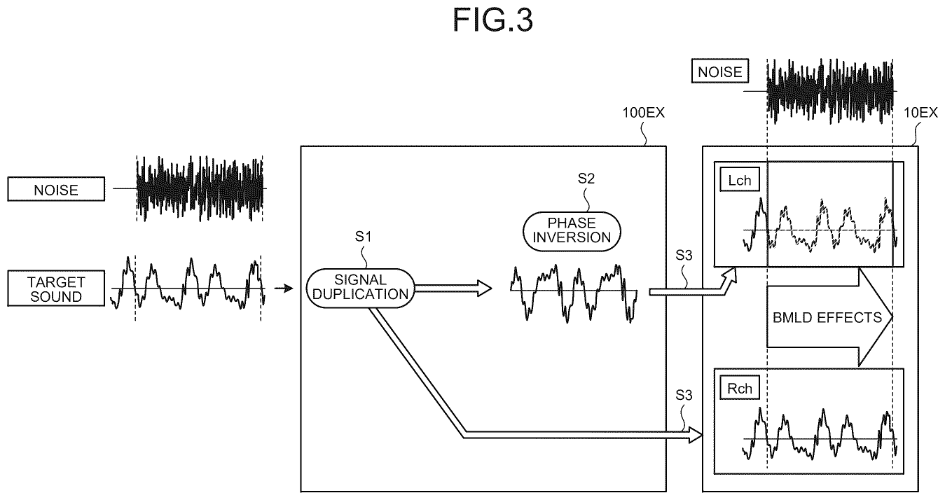

In the following explanation, an overview of a signal processing method according to a comparative example is explained. FIG. 3 is a diagram illustrating an example of the signal processing method according to the comparative example.

As illustrated in FIG. 3, a reproduction device 100EX according to the comparative example duplicates target sound (a monophonic signal) reproduced in a noise environment (step S1). The duplicated target sound is treated as sound signals for left and right two channels.

The reproduction device 100EX according to the comparative example inverts a phase of one sound signal of the sound signals for the two channels (step S2). Note that the reproduction device 100EX according to the comparative example does not invert a phase of the other sound signal.

The reproduction device 100EX according to the comparative example outputs the sound signal with the inverted phase and the sound signal with the non-inverted phase to a sound output device 10EX while synchronizing the sound signals. For example, of the sound signals of the two channels the reproduction device 100EX outputs the sound signal with the inverted phase through a functional channel and outputs the sound signal with the non-inverted phase through a non-functional channel. For example, the reproduction device 100EX outputs the sound signal with the inverted phase to a unit for the left ear corresponding to a functional channel (Lch) in the sound output device 10EX. The reproduction device 100EX outputs the sound signal with the non-inverted phase to a unit for the right ear corresponding to a non-functional channel (Rch) in the sound output device 10EX (step S3). Accordingly, the sound output device 10EX can provide, to a user wearing the sound output device 10EX, target sound to which the effects of the BMLD is imparted in a noise environment.

### <2-2. Overview of a Signal Processing Method According to the First Embodiment>

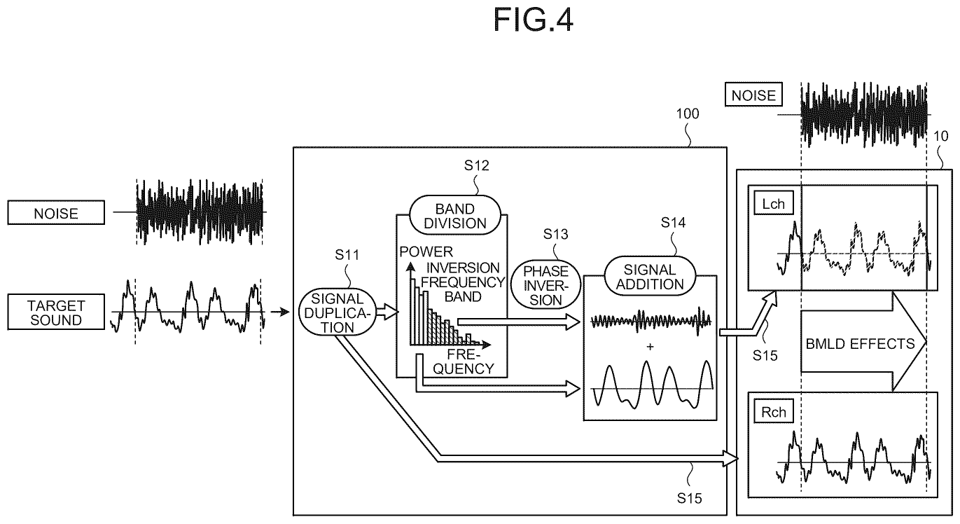

In the following explanation, an overview of a signal processing method according to the embodiment of the present disclosure is explained. The signal processing method according to the embodiment of the present disclosure is different from the signal processing method according to the comparative example in that only a specific frequency band of target sound is phase-inverted. For example, the signal processing method according to the embodiment of the present disclosure phase-inverts only a sound component of a frequency band that less easily affects phase difference perception of sound between both the ears (between the left ear and the right ear). Accordingly, the signal processing method according to the embodiment of the present disclosure can make it easy to listen to, for example, a high-frequency side of a frequency band of target sound in which a phase difference of sound between both the ears is less easily perceived. FIG. 4 is a diagram illustrating an example of the signal processing method according to the embodiment of the present disclosure.

As illustrated in FIG. 4, a reproduction device 100 according to the embodiment duplicates target sound (a monophonic signal) reproduced in a noise environment (step S11). Here, the reproduction device 100 temporarily stores either target sound (an original sound signal) or duplicated sound (a duplicated signal) obtained by duplicating the target sound. Note that arbitrary sound such as music or voice is assumed as the target sound.

Subsequently, the reproduction device 100 divides a band of either the target sound (the original sound signal) or the duplicated sound (the duplicated signal) obtained by duplicating the target sound into an inversion frequency band set as a phase inversion target and a non-inversion frequency band not set as a phase inversion target (step S12). For example, the reproduction device 100 executes a frequency analysis for either the original sound signal or the duplicated signal (hereinafter collectively referred to as “sound signal”) and divides the sound signal in a frequency domain. Specifically, the reproduction device 100 divides the sound signal into an inversion frequency band and a non-inversion frequency based on frequency characteristics of the sound signal obtained by the frequency analysis.

In the case of voice of specific persons or sound of specific musical instruments, as the inversion frequency band, unique values may be determined for the persons or the musical instruments by, for example, analyzing a power distribution of a frequency in advance. The inversion frequency band may change from moment to moment according to a frequency distribution. Note that, although an inversion frequency band having a high-pass characteristic is exemplified in FIG. 4, the inversion frequency band can be optionally adjusted according to, for example, frequency characteristics of target sound. The inversion frequency band may have a low-pass characteristic or a band-pass characteristic. For example, as explained above, the reproduction device 100 may determine the inversion frequency band of the target sound using the frequency dependence of the BMLD. Note that, although FIG. 4 illustrates an example of the frequency characteristics of the target sound, a frequency component included in the target sound is not limited to the example illustrated in FIG. 4. When the target sound includes any frequency component, the inversion frequency band of the target sound can be determined in the same manner using the frequency dependence of the BMLD.

Subsequently, the reproduction device 100 inverts a phase of a first sound signal belonging to the inversion frequency band in the band of the sound signal (step S13) and generates an inverted signal.

Subsequently, the reproduction device 100 adds up the inverted signal and a second sound signal belonging to a non-inversion frequency band in the band of the sound signal (step S14) and generates an addition signal. Accordingly, the reproduction device 100 partially imparts the effects of the BMLD to the target sound.

Then, the reproduction device 100 outputs the addition signal generated in step S14 and the temporarily stored original sound signal or duplicated signal to a sound output device 10 while synchronizing the addition signal and the sound signal or the duplicated signal (step S15).

As explained above, the reproduction device 100 according to the embodiment of the present disclosure can impart the effects of the BMLD for a specific frequency band by phase-inverting only the specific frequency band and can give natural audibility to a listener in the signal processing to which the binaural masking level difference is applied.

### <2-3. System Configuration Example>

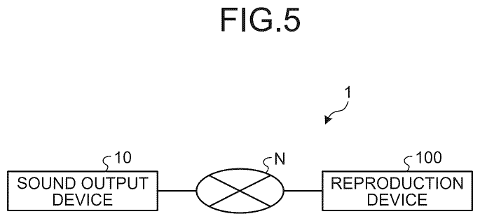

In the following explanation, a configuration of an information processing system 1A according to the first embodiment of the present disclosure is explained with reference to FIG. 5. FIG. 5 is a diagram illustrating a configuration example of the information processing system according to the first embodiment of the present disclosure.

As illustrated in FIG. 5, the information processing system 1A according to the first embodiment includes the sound output device 10 and the reproduction device 100. The sound output device 10 and the reproduction device 100 are connected to a network N. The sound output device 10 and the reproduction device 100 can communicate with each other via the network N. Note that the sound output device 10 and the reproduction device 100 are not limited to be wirelessly connected and may be connected by wire via a predetermined interface.

The network N may include a public line network such as the Internet, a telephone line network, or a satellite communication network, various local area networks (LANs) including Ethernet (registered trademark), or a wide area network (WAN). The network N may include a dedicated line network such as an IP-VPN (Internet Protocol-Virtual Private Network). The network N may include a wireless communication network such as Wi-Fi (registered trademark) or Bluetooth (registered trademark).

The sound output device 10 is a device that outputs sound corresponding to a sound signal transmitted from the reproduction device 100. The sound output device 10 is, for example, headphones, earphones, a headset, or the like for stereo reproduction.

The reproduction device 100 is an information processing device that transmits a sound signal corresponding to a sound source (music content or voice content), call voice, or the like to the sound output device 10. The reproduction device 100 can be implemented by a PC (Personal Computer), a notebook PC, a tablet terminal, a smartphone, a PDA (Personal Digital Assistant), or the like.

Note that the information processing system 1A is not limited to an example in the information processing system 1A is configured to include the sound output device 10 and the reproduction device 100 physically independent of each other and may be a physically integrated information processing terminal like a wearable device such as an HMD (Head Mounted Display).

### <2-4. Device Configuration Example>

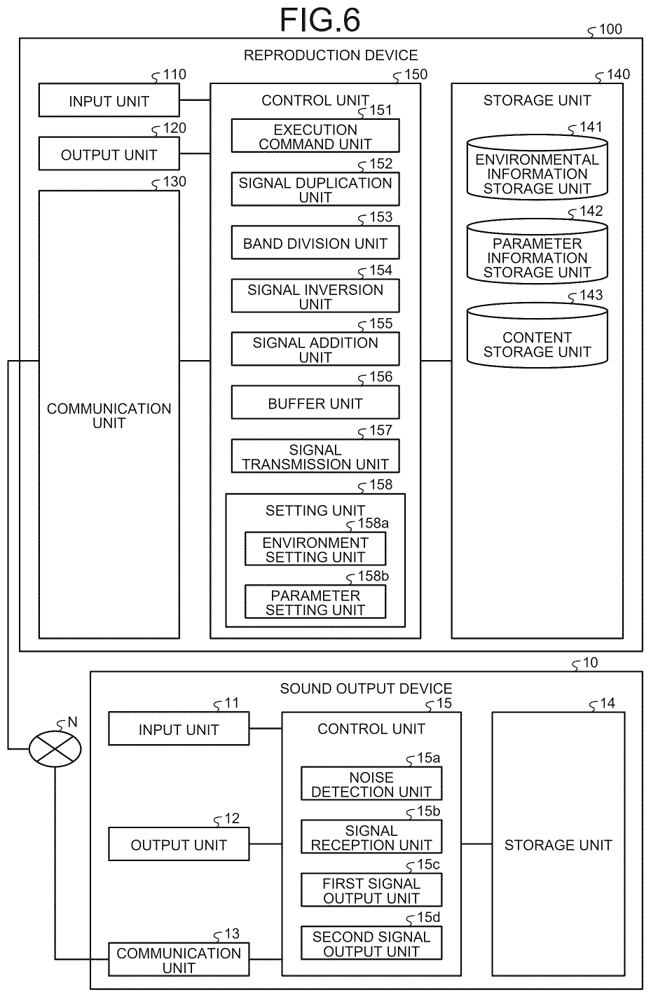

In the following explanation, a device configuration of the devices included in the information processing system 1A according to the first embodiment of the present disclosure is explained with reference to FIG. 6. FIG. 6 is a block diagram illustrating the device configuration example of the devices included in the information processing system according to the first embodiment of the present disclosure.

### (2-4-1. Configuration Example of the Sound Output Device)

As illustrated in FIG. 6, the sound output device 10 included in the information processing system 1A includes an input unit 11, an output unit 12, a communication unit 13, a storage unit 14, and a control unit 15. Note that FIG. 6 illustrates an example of a functional configuration of the sound output device 10 according to the first embodiment. The sound output device 10 is not limited to the example illustrated in FIG. 6 and may have another configuration.

The input unit 11 receives input of various kinds of operation. The input unit 11 can include a switch, a button, or the like for receiving input of, for example, operation for changing the volume of a sound source (music content, voice content, call voice, or the like) being output. When the sound output device 10 is a headset, the input unit 11 includes a voice input device such as a microphone that inputs voice and the like a user. For example, the input unit 11 can acquire sound (environmental sound) around the sound output device 10. The input unit 11 passes a sound signal of the acquired sound to the control unit 15 explained below. The input unit 11 may include a photographing device such as a digital camera that photographs the user and the surroundings of the user.

The output unit 12 outputs sound corresponding to sound signals of two channels received from the reproduction device 100. The output unit 12 is implemented by an output device such as a speaker. When the sound output device 10 is, for example, dynamic-type headphones, the output unit 12 includes a driver unit that reproduces a sound signal received from the reproduction device 100. The output unit 12 includes a unit for right ear that outputs sound to the right ear of the user and a unit for left ear that outputs sound to the left ear of the user.

The communication unit 13 transmits and receives various kinds of information. The communication unit 13 is implemented by a communication module or the like for transmitting and receiving data to and from another device such as the reproduction device 100 by wire or radio. For example, the communication unit 13 can include a communication module for communicating with another device such as the reproduction device 100 in a scheme such as a wired LAN (Local Area Network), a wireless LAN, Wi-Fi (registered trademark), infrared communication, Bluetooth (registered trademark), or short range or non-contact communication.

For example, the communication unit 13 can transmit and receive control information for wireless connection to the reproduction device 100, information concerning compression of a sound signal, and the like to and from the reproduction device 100. For example, the communication unit 13 receives a sound signal transmitted from the reproduction device 100. For example, the communication unit 13 can transmit, to the reproduction device 100, a change request for changing the volume of a sound source (music content, voice content, call voice, or the like) being output.

The storage unit 14 is implemented by, for example, a semiconductor memory element such as a RAM (Random Access Memory) or a flash memory or a storage device such as a hard disk or an optical disk. For example, the storage unit 14 can store programs, data, and the like for implementing various processing functions to be executed by the control unit 15. The programs stored by the storage unit 14 include an OS (Operating System) and various application programs. For example, the storage unit 14 can store a program and control information for executing pairing with the reproduction device 100, a program for executing processing concerning a sound signal received from the reproduction device 100, a program and data for executing information processing according to the first embodiment, and the like.

The control unit 15 is implemented by a control circuit including a processor and a memory. The various kinds of processing to be executed by the control unit 15 are implemented by, for example, commands described in programs read from an internal memory by a processor being executed using the internal memory as a work area. The programs read from the internal memory by the processor include an OS (Operating System) and application programs. The control unit 15 may be implemented by, for example, an integrated circuit such as an ASIC (Application Specific Integrated Circuit), an FPGA (Field-Programmable Gate Array), or an SoC (System-on-a-Chip).

The main storage device and an auxiliary storage device functioning as the internal memory explained above are implemented by, for example, a semiconductor memory element such as a RAM (Random Access Memory) or a flash memory or a storage device such as a hard disk or an optical disk.

As illustrated in FIG. 6, the control unit 15 includes a noise detection unit 15a, a signal reception unit 15b, a first signal output unit 15c, and a second signal output unit 15d.

The noise detection unit 15a detects noise (for example, white noise) around the sound output device 10 in real time at predetermined short time bin intervals. For example, the noise detection unit 15a determines whether a sound pressure level of a sound signal of environmental sound acquired by the input unit 11 is equal to or higher than a predetermined threshold. When determining that the sound pressure level of the sound signal of the environmental sound is equal to or higher than the predetermined threshold, the noise detection unit 15a transmits a command signal (ON) for requesting execution of the signal processing method according to the first embodiment to the reproduction device 100 through the communication unit 13. After transmitting the command signal (ON) for requesting a start of the execution of the signal processing method according to the first embodiment, when determining that the sound pressure level of the sound signal of the environmental sound is lower than the predetermined threshold, the noise detection unit 15a transmits a command signal (OFF) for requesting an end of the execution of the signal processing method according to the first embodiment to the reproduction device 100 via the communication unit 13.

The signal reception unit 15b receives, through the communication unit 13, sound signals of two channels transmitted from the reproduction device 100. The signal reception unit 15b transmits the received sound signals of the two channels respectively to the first signal output unit 15c and the second signal output unit 15d of the corresponding channels. For example, when the first signal output unit 15c corresponds to a functional channel (for example, “Lch”), the signal reception unit 15b transmits a sound signal corresponding to the functional channel to the first signal output unit 15c. When the second signal output unit 15d corresponds to a non-functional channel (for example, “Rch”), the signal reception unit 15b transmits a sound signal corresponding to the non-functional channel to the second signal output unit 15d.

The first signal output unit 15c outputs the sound signal acquired from the signal reception unit 15b to a unit (for example, the unit for left ear) corresponding to the functional channel through a path corresponding to the functional channel (for example, “Lch”).

The second signal output unit 15d outputs the sound signal acquired from the signal reception unit 15b to a unit (for example, the unit for right ear) corresponding to the non-functional channel through a path corresponding to the non-functional channel (for example, “Rch”)

### (2-4-2. Configuration Example of the Reproduction Device)

In the following explanation, a configuration example of the reproduction device 100 according to the first embodiment of the present disclosure is explained. As illustrated in FIG. 6, the reproduction device 100 included in the information processing system 1A includes an input unit 110, an output unit 120, a communication unit 130, a storage unit 140, and a control unit 150.

The input unit 110 receives input of various kinds of operation. The input unit 110 can include a switch, a button, or the like for receiving input such as operation for changing the volume of a sound source (music content, voice content, call voice, or the like) being output. The input unit 11 may include a photographing device such as a digital camera that photographs the user and the surroundings of the user.

For example, the input unit 110 receives operation input from the user through a user interface output to the output unit 120 by the control unit 150 explained below. The input unit 110 passes information concerning the operation input to the control unit 150 explained below.

The output unit 120 outputs various kinds of information. The output unit 120 is implemented by an output device such as a display or a speaker. For example, the output unit 120 displays, in response to a request from the control unit 150 explained below, a user interface for receiving operation input from the user.

The communication unit 130 transmits and receives various kinds of information. The communication unit 130 is implemented by a communication module or the like for transmitting and receiving data to and from other devices such as the sound output device 10 by wire or radio. For example, the communication unit 130 can include a communication module for communicating with the other devices such as the sound output device 10 in a scheme such as a wired LAN (Local Area Network), a wireless LAN, Wi-Fi (registered trademark), infrared communication, Bluetooth (registered trademark), or short range or non-contact communication.

For example, the communication unit 130 transmits a sound signal or the like generated by the control unit 150 explained below to the sound output device 10. The communication unit 130 receives, from the sound output device 10, a command signal for requesting execution of the signal processing method according to the first embodiment. The communication unit 130 transmits control information for wireless connection to the sound output device 10, information concerning compression of a sound signal, and the like to the sound output device 10.

The storage unit 140 is implemented by, for example, a semiconductor memory element such as a RAM (Random Access Memory) or a flash memory or a storage device such as a hard disk or an optical disk. For example, the storage unit 14 can store programs, data, and the like for implementing various processing functions to be executed by the control unit 15. The programs stored by the storage unit 14 include an OS (Operating System) and various application programs.

As illustrated in FIG. 6, the storage unit 140 includes an environmental information storage unit 141, a parameter information storage unit 142, and a content storage unit 143.

The environmental information storage unit 141 the user. For example, the information concerning the environment setting stored in the environmental information storage unit 141 includes information concerning a functional channel selected by the user.

The parameter information storage unit 142 stores information concerning parameters for signal processing set by the user. For example, the parameters for signal processing stored in the parameter information storage unit 142 include information indicating a band for dividing, in a sound signal, an inversion frequency band set as a target of phase inversion processing and a non-inversion frequency band not set as a target of the phase inversion processing.

The content storage unit 143 stores information concerning sound sources such as music content and voice content. The information concerning these sound sources can be target sound to be processed by the signal processing method according to the first embodiment.

The control unit 150 is implemented by a control circuit including a processor and a memory. Various kinds of processing to be executed by the control unit 150 are implemented by, for example, commands described in programs read from an internal memory by the processor being executed using the internal memory as a work area. The programs read from the internal memory by the processor include an OS (Operating System) and application programs. The control unit 150 may be implemented by an integrated circuit such as an ASIC (Application Specific Integrated Circuit), an FPGA (Field-Programmable Gate Array), an SoC (System-on-a-Chip).

As illustrated in FIG. 6, the control unit 150 includes an execution command unit 151, a signal duplication unit 152, a band division unit 153, a signal inversion unit 154, a signal addition unit 155, a buffer unit 156, a signal transmission unit 157, and a setting unit 158. Among these units included in the control unit 150, the signal duplication unit 152, the band division unit 153, the signal inversion unit 154, the signal addition unit 155, the buffer unit 156, and the setting unit 158 configure a signal processing block that provides a function for executing the signal processing method according to the first embodiment.

The execution command unit 151 controls, according to a command signal transmitted from the sound output device 10, the signal processing block to execute processing concerning the signal processing method according to the first embodiment.

The signal duplication unit 152 generates a duplicated signal obtained by duplicating a sound signal corresponding to a sound source or the like stored in the content storage unit 143.

The band division unit 153 divides one band of either a sound signal corresponding to an original sound source and a duplicated signal generated by the signal duplication unit 152 into an inversion frequency band set as a phase inversion target and a non-inversion frequency band not set as a phase inversion target.

The signal inversion unit 154 generates an inverted signal obtained by inverting a phase of a first sound signal belonging to the inversion frequency band.

The signal addition unit 155 generates an addition signal obtained by adding up the inverted signal and a second sound signal belonging to the non-inversion frequency band.

The buffer unit 156 temporarily stores the sound signal corresponding to the original sound source or the duplicated signal generated by the signal duplication unit 152.

The signal transmission unit 157 outputs the addition signal generated by the signal addition unit 155 and the sound signal or the duplicated signal stored in the buffer unit 156 to the sound output device 10 via the communication unit 130 while synchronizing the addition signal and the sound signal or the duplicated signal.

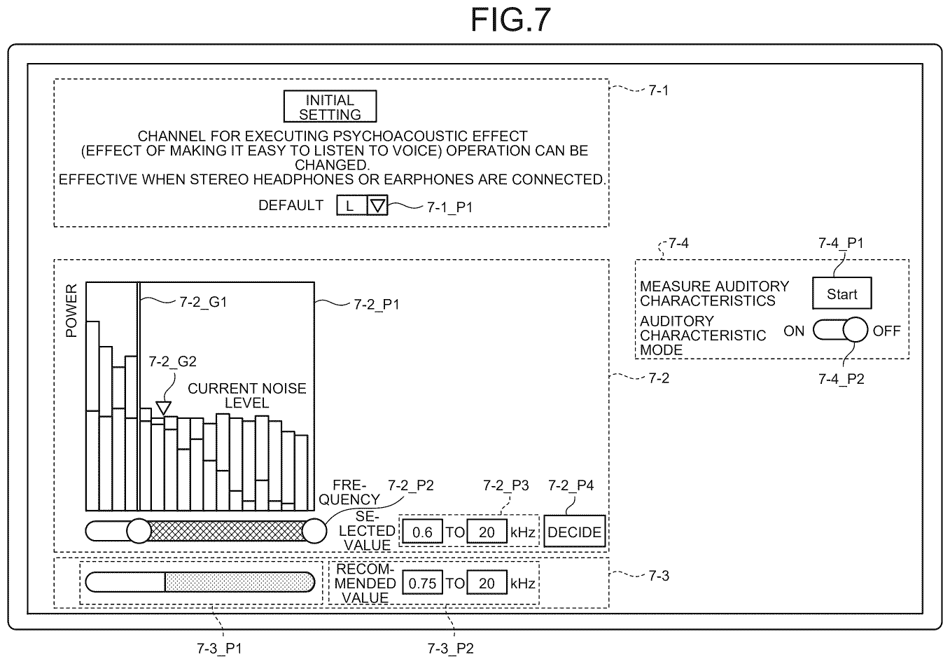

The setting unit 158 receives various settings through a user interface provided to the user. As illustrated in FIG. 6, the setting unit 158 includes an environment setting unit 158a and a parameter setting unit 158b. FIG. 7 is a diagram illustrating an example of a user interface according to the first embodiment of the present disclosure.

The environment setting unit 158a receives selection of a functional channel from the user through an initial setting area 7-1 of a setting screen (a user interface) exemplified in FIG. 7. The initial setting area 7-1 illustrated in FIG. 7 includes an operation unit 7-1_P1 that receives selection operation for a functional channel from the user. FIG. 7 illustrates a state in which the channel (Lch) corresponding to the left side unit of the sound output device 10 is selected as the functional channel.

The parameter setting unit 158b sets a band for dividing the inversion frequency band and the non-inversion frequency band. The parameter setting unit 158b may change the inversion frequency band at any time and automatically according to characteristics of target sound and characteristics of the user. For example, in the case of voice of specific persons or sound of specific musical instruments, the parameter setting unit 158b may determine unique values for the persons and the musical instruments as a band for dividing the inversion frequency band and the non-inversion frequency band by, for example, analyzing a power distribution of a frequency in advance.

The parameter setting unit 158b may change the inversion frequency band from moment to moment according to a frequency distribution of the target sound. Note that the parameter setting unit 158b is capable of optionally adjusting the inversion frequency band according to a frequency characteristic or the like of the target sound. The frequency characteristic may be a high-pass characteristic, a low-pass characteristic, or a band-pass characteristic. For example, as explained above, the parameter setting unit 158b may determine the inversion frequency band of the target sound using the frequency dependence of the BMLD. The parameter setting unit 158b can also determine the inversion frequency band of the target sound using the frequency dependence of the BMLD regardless of what kind of a frequency component the target sound includes.

The parameter setting unit 158b may acquire data of auditory characteristics of the user by, for example, measuring the auditory characteristics of the user in advance as an example of the characteristics of the user explained above and change the inversion frequency band at any time according to the data. Here, the auditory characteristics of the user may be general-purpose characteristics or characteristics specific to the individual user (personal characteristics). The parameter setting unit 158b may manually receive setting of the inversion frequency band from the user. In this case, the parameter setting unit 158b may present a power distribution of a frequency analyzed by the band division unit 153 and an optimum value of the inversion frequency band and enable the user to select the power distribution of the frequency and the optimum value of the inversion frequency band. When the user uses, for example, a hearing aid or a sound collector, the parameter setting unit 158b may acquire data from a hearing test result, an audiogram, and the like of the user.

For example, the parameter setting unit 158b receives, from the user, through the band setting area 7-2 of the setting screen exemplified in FIG. 7, setting of a boundary value for separating the inversion frequency band and the non-inversion frequency band. The band setting area 7-2 exemplified in FIG. 7 includes a frequency distribution display area 7-2_P1, an operation unit 7-2_P2, a display area 7-2_P3, and a decision button 7-2_P4.

The frequency distribution display area 7-2_P1 displays, in a region including the horizontal axis indicating a frequency and the vertical axis indicating power (a sound pressure level), a power distribution of a frequency of target sound to be reproduced. FIG. 7 illustrates an example in which a frequency power distribution of current noise is displayed on a power distribution of a frequency of target sound in the frequency distribution display area 7-2_P1. The frequency distribution display area 7-2_P1 displays, in association with operation on the operation unit 7-2_P2, an image 7-2_G1 indicating a band being selected and an image 7-2_G2 indicating a recommended value of the band displayed in the display area 7-2_P3.

The operation unit 7-2_P2 receives, from the user, operation for designating a boundary value (a band) for separating the inversion frequency band and the non-inversion frequency band. FIG. 7 illustrates an example in which the operation unit 7-2_P2 includes a slide bar (also referred to as slider) that enables the user to designate a band for dividing the inversion frequency band and the non-inversion frequency band with intuitive operation. The operation unit 7-2_P2 is configured to be capable of selecting any band such as a high-pass, low-pass, or band-pass band.

The display area 7-2_P3 displays the selected band being selected in association with the operation on the operation unit 7-2_P2. The decision button 7-2_P4 receives, from the user, operation of deciding the setting of the boundary value for dividing the inversion frequency band and the non-inversion frequency band. Note that the boundary value may be set in advance or may be sequentially set.

The parameter setting unit 158b presents a recommended value of a band for dividing the inversion frequency band and the non-inversion frequency band to the user in a recommended value display area 7-3 of the setting screen (the user interface) exemplified in FIG. 7. For example, the parameter setting unit 158b estimates, based on the power distribution of the frequency of the target sound, while maintaining the BMLD effects, an inversion frequency band in which auditory discomfort is less easily given to the user.

The parameter setting unit 158b receives an auditory characteristic measurement instruction from the user through an auditory characteristic measurement reception area 7-4 of the setting screen (the user interface) exemplified in FIG. 7. The auditory characteristic measurement reception area 7-4 includes a start button 7-4 P1 for starting measurement of auditory characteristics and a switch button 7-4_P2 for switching enabling and disabling of the function of the auditory characteristic mode. The user can execute the measurement of the auditory characteristics by switching the switch button 7-4_P2 to “ON” and operating the start button 7-4 P1.

For example, the parameter setting unit 158b can execute the auditory measurement of the user based on a processing module for auditory measurement incorporated in the reproduction device 100 in advance. When the auditory measurement has been executed, the parameter setting unit 158b can store data of auditory characteristics for each user. Note that the setting screen (the user interface) exemplified in FIG. 7 is only an example. A disposition example of screens and buttons is not limited to this example. For example, the setting screen (the user interface) may have a voice recognition function and, instead of the user determining a selection value or a recommended value of a frequency band with a slide bar or input operation, determine those values by receiving voice of the user.

### (2-4-3. Specific Example of the Units of the Reproduction Device)

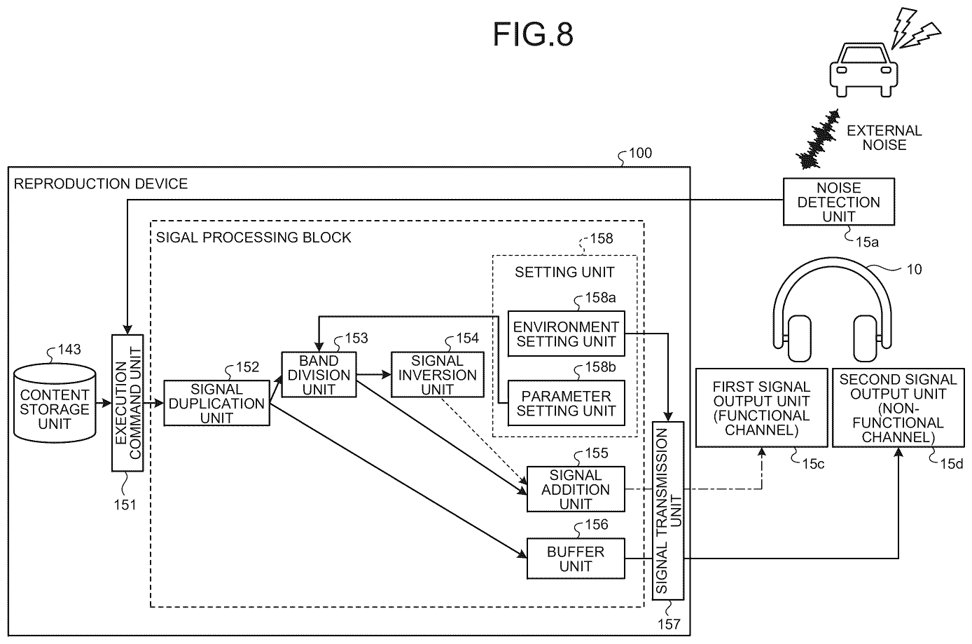

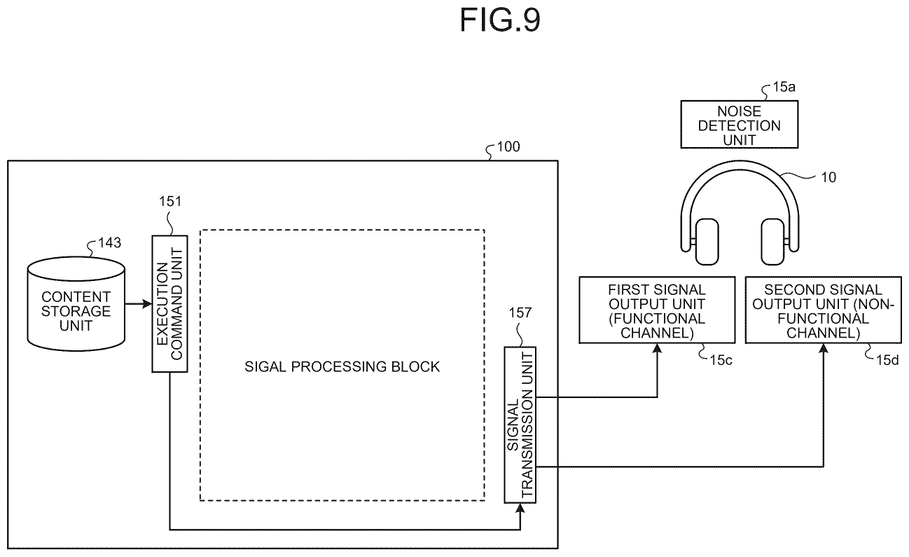

In the following explanation, a specific example of the units of the reproduction device 100 is explained with reference to the drawings. FIG. 8 and FIG. 9 are diagrams for explaining a specific example of the units of the reproduction device according to the first embodiment of the present disclosure. Note that, in the following explanation, operations of the units in the case of executing the signal processing method of performing band division on a sound signal of target sound in a frequency domain is explained.

As illustrated in FIG. 8, for example, after receiving a command signal from the sound output device 10 (the noise detection unit 15a), the execution command unit 151 instructs the signal processing block to start processing concerning the signal processing method according to the first embodiment. The execution command unit 151 reads, from the content storage unit 143, a sound signal (a monophonic signal) corresponding to target sound being reproduced and sends the sound signal to the signal processing block.

The signal duplication unit 152 duplicates the sound signal (the monophonic signal) read from the content storage unit 143 to generate a duplicated signal and prepares sound signals for two channels for a functional channel and for a non-functional channel. The signal duplication unit 152 sends one sound signal to the band division unit 153 and sends the other sound signal to the buffer unit 156.

The band division unit 153 performs Fourier transform on the sound signal acquired from the signal duplication unit 152 to analyze frequency characteristics of the sound signal. The band division unit 153 refers to parameters stored in the parameter information storage unit 142, determines an inversion frequency band corresponding to an analysis result of the frequency characteristics, and executes band division for dividing the sound signal into a component of the inversion frequency band and a component of a non-inversion frequency band. The band division unit 153 generates a first sound signal obtained by performing inverse Fourier transform on the component of the inversion frequency band and sends the first sound signal to the signal inversion unit 154 and generates a second sound signal obtained by performing inverse Fourier transform on the component of the non-inversion frequency band and sends the second sound signal to the signal addition unit 155.

The signal inversion unit 154 executes phase inversion processing of inverting a phase of the first sound signal corresponding to the component of the inversion frequency band and sends an inverted signal after the phase inversion to the signal addition unit 155.

The signal addition unit 155 generates an addition signal obtained by adding up the inverted signal acquired from the signal inversion unit 154 and the second sound signal acquired from the band division unit 153. The signal addition unit 155 sends the generated addition signal to the signal transmission unit 157.

The buffer unit 156 temporarily stores the sound signal acquired from the signal duplication unit 152 and puts the sound signal on standby until the addition signal is sent from the signal addition unit 155 to the signal transmission unit 157. In order to perform, in real time, processing of dividing a band of a sound signal in a frequency domain, the band division unit 153 requires sufficient samples to be used for an analysis of the frequency characteristics of the target sound. For this reason, when the band of the sound signal of the target sound is divided in the frequency domain, first, a time for accumulating sufficient samples is required and a time for analyzing frequency characteristics in real time is also required. Therefore, for example, the buffer unit 156 monitors a processing situation in the signal addition unit 155 and sends the temporarily stored sound signal to the signal transmission unit 157 at timing when the addition signal is sent from the signal addition unit 155 to the signal transmission unit 157.

When having acquired the addition signal from the signal addition unit 155 and having acquired the sound signal from the buffer unit 156, the signal transmission unit 157 transmits the acquired signals to the sound output device 10 through the corresponding functional channel while synchronizing the signals. For example, the signal transmission unit 157 specifies a functional channel referring to the information concerning the environment setting received by the environment setting unit 158a or the information concerning the environment setting stored in the environmental information storage unit 141. Then, the signal transmission unit 157 transmits the addition signal acquired from the signal addition unit 155 to the first signal output unit 15c of the sound output device 10 corresponding to the functional channel through the functional channel and outputs the sound signal acquired from the buffer unit 156 to the second signal output unit 15d of the sound output device 10 corresponding to the functional channel through a non-functional channel.

As illustrated in FIG. 9, for example, while a command signal is not received from the sound output device 10 (the noise detection unit 15a), the execution command unit 151 reads, from the content storage unit 143, a sound signal (a monophonic signal) corresponding to the target sound being reproduced and directly sends the read sound signal to the signal transmission unit 157 not through the signal processing block.

When having directly acquired the sound signal from the execution command unit 151, the signal transmission unit 157 duplicates the acquired sound signal to generate a duplicated signal and prepares sound signals for two channels for the functional channel and the non-functional channel. Then, the signal transmission unit 157 transmits the sound signals to the sound output device 10 through the functional channels while synchronizing the sound signals.

### (2-4-4. Modification of the Units of the Reproduction Device)

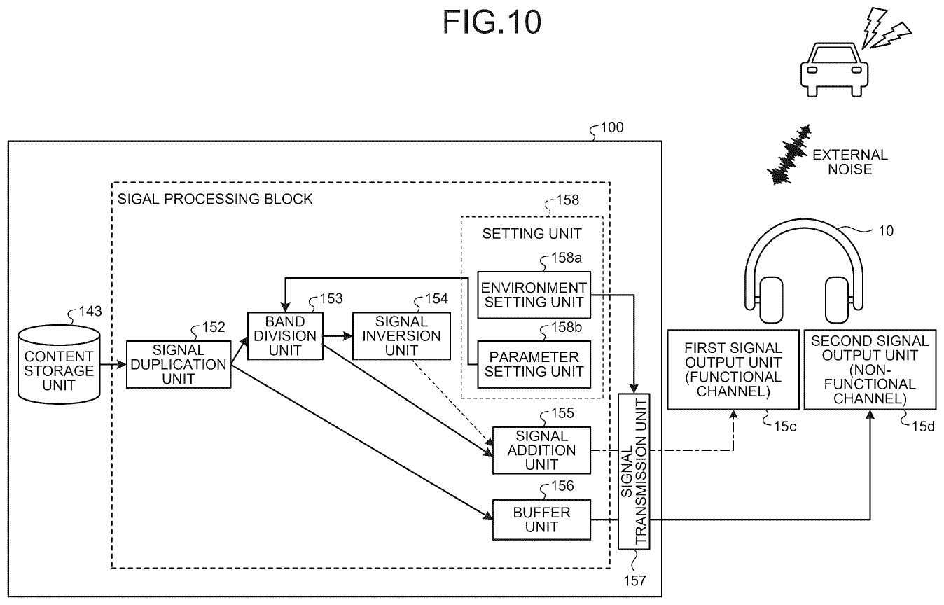

A modification of the units of the reproduction device 100 is explained with reference to FIG. 10. FIG. 10 is a diagram for explaining a modification of the units of the reproduction device according to the first embodiment of the present disclosure. The reproduction device 100 according to the modification illustrated in FIG. 10 is different from the reproduction device 100 illustrated in FIG. 8 and FIG. 9 in that the reproduction device 100 according to the modification does not include the execution command unit 151. Note that the sound output device 10 also does not include the noise detection unit 15a. That is, the reproduction device 100 according to the modification executes the signal processing method according to the first embodiment while reproducing target sound regardless of presence or absence of a command signal from the sound output device 10. Note that processing of the signal processing block is the same as the processing explained with reference to FIG. 8. Therefore, detailed explanation of the processing is omitted.

### <2-5. Processing Procedure Example>

### (2-5-1. Processing Procedure in a Frequency Domain)

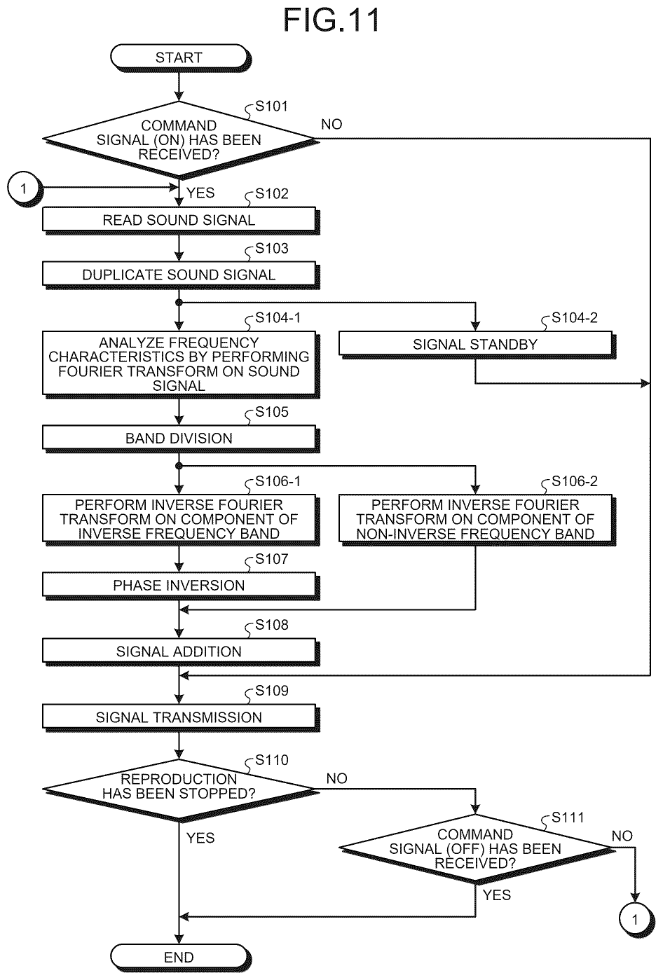

In the following explanation, a processing procedure by the reproduction device 100 according to the first embodiment of the present disclosure is explained with reference to FIG. 11. FIG. 11 is a flowchart illustrating an example of a processing procedure (part 1) of the signal processing method according to the first embodiment of the present disclosure. FIG. 11 illustrates an example of a processing procedure in the case in which a band of a sound signal is divided in a frequency domain. The processing procedure illustrated in FIG. 11 is started according to reproduction of target sound such as music content or voice content. The processing procedure illustrated in FIG. 11 is repeatedly executed for each predetermined processing unit (short time bin) for dividing target sound during reproduction of the target sound. The processing procedure illustrated in FIG. 11 is executed by the control unit 150 included in the reproduction device 100.

As illustrated in FIG. 11, the execution command unit 151 determines whether a command signal (ON) for requesting a start of execution of the signal processing method according to the first embodiment has been received (step S101).

When determining that the command signal has been received (step S101; Yes), the execution command unit 151 reads, from the content storage unit 143, a sound signal (a monophonic signal) corresponding to target sound being reproduced (step S102).

The signal duplication unit 152 duplicates the read sound signal (monophonic signal) (step S103) and generates a duplicated signal. The signal duplication unit 152 sends one sound signal to the band division unit 153 and sends the other sound signal to the buffer unit 156.

The band division unit 153 analyzes frequency characteristics of the sound signal by performing Fourier transform on the sound signal acquired from the signal duplication unit 152 (step S104-1). The buffer unit 156 temporarily stores the sound signal acquired from the signal duplication unit 152 and puts the sound signal on standby (step S104-2).

The band division unit 153 executes band division for the sound signal into a component of an inversion frequency band and a component of a non-inversion frequency band based on an analysis result of the frequency characteristics (step S105). The band division unit 153 generates a first sound signal obtained by performing inverse Fourier transform on the component of the inversion frequency band and sends the first sound signal to the signal inversion unit 154 and generates a second sound signal obtained by performing inverse Fourier transform on the component of the non-inversion frequency band and sends the second sound signal to the signal addition unit 155.

The signal inversion unit 154 executes phase inversion processing of inverting a phase of the first sound signal corresponding to the component of the inversion frequency band (step S106). The phase inversion unit 104 sends an inverted signal after the phase inversion to the signal addition unit 155.

The signal addition unit 155 adds up the inverted signal acquired from the signal inversion unit 154 and the second sound signal acquired from the band division unit 153 (step S107) to generate an addition signal. The signal addition unit 155 sends the generated addition signal to the signal transmission unit 157.

When acquiring the addition signal from the signal addition unit 155 and acquiring the sound signal from the buffer unit 156, the signal transmission unit 157 transmits the acquired signals to the sound output device 10 through a corresponding functional channel while synchronizing the signals (step S108).

The execution command unit 151 determines whether reproduction of content has been stopped (step S110).

When determining that the reproduction of the content has been stopped (step S110; Yes), the execution command unit 151 ends the processing procedure illustrated in FIG. 11.

On the other hand, when determining that the reproduction of the content has not been stopped (step S110; No), the execution command unit 151 determines whether a command signal (OFF) for requesting an execution end of the signal processing method according to the first embodiment has been received (step S111).

When determining that the command signal (OFF) for requesting the execution end of the signal processing method according to the first embodiment has been received (step S111; Yes), the execution command unit 151 ends the processing procedure illustrated in FIG. 11.

When determining that the command signal (OFF) for requesting the execution end of the signal processing method according to the first embodiment has not been received (step S111; No), the execution command unit 151 returns to step S102 explained above and reads, from the content storage unit 143, a sound signal (a monophonic signal) corresponding to target sound being reproduced.

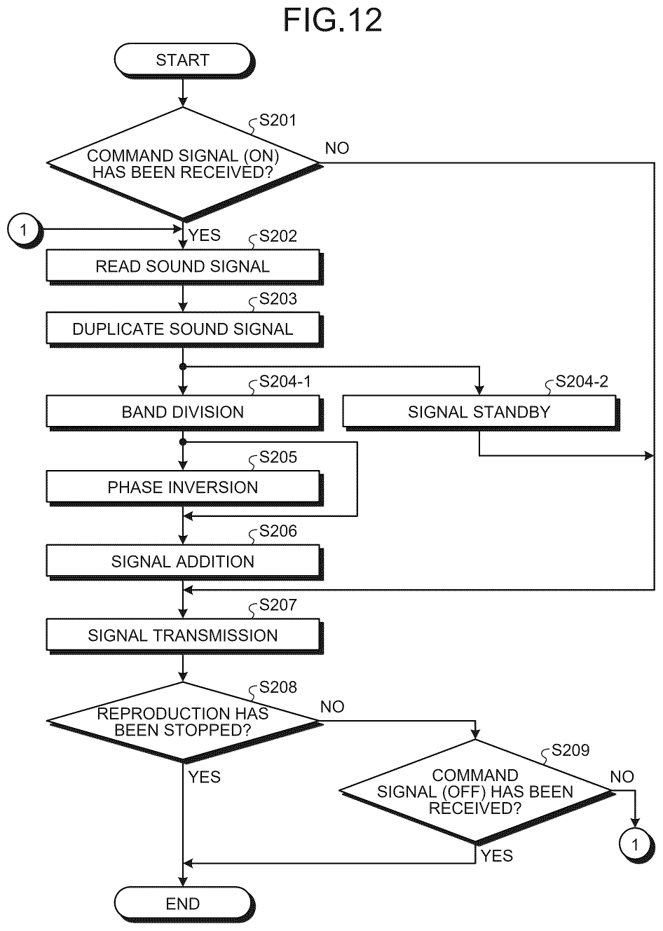

(2-5-2. Processing procedure in a time domain) In the first embodiment explained above, the reproduction device 100 may execute the band division for the sound signal of the target sound not in the frequency domain but in a time domain. In the following explanation, an example of a processing procedure in the case in which a band of a sound signal is divided in the time domain is explained with reference to FIG. 12. FIG. 12 is a flowchart illustrating an example of a processing procedure (part 2) of the signal processing method according to the first embodiment of the present disclosure. The processing procedure illustrated in FIG. 12 is repeatedly executed for each sample of a target sound during reproduction of the target sound. The processing procedure illustrated in FIG. 12 is different from the processing procedure illustrated in FIG. 11 in processing procedures in step S204-1 and step S204-2. In the processing procedure illustrated in FIG. 12, the processing procedures in step S104-1, step S106-1, and step S106-2 included in the processing procedure illustrated in FIG. 11 are unnecessary.

That is, a processing procedure from step S201 to step S203 is the same as the processing procedure from step S101 to step S103 illustrated in FIG. 11.

Then, the band division unit 153 divides a band of the sound signal using a band division filter (step S204-1). The band division unit 153 divides the band of the sound signal by executing a convolution operation of the sound signal using a band division filter generated in advance in order to divide the sound signal in the time domain.

The buffer unit 156 temporarily stores the sound signal acquired from the signal duplication unit 152 and puts the sound signal on standby (step S204-2). At this time, the buffer unit 156 calculates a sample shift (a time shift) that can be caused by the calculation using the band division filter and puts the sound signal on standby until a time corresponding to the calculated sample shift elapses. Note that the sample shift (the time shift) is determined by a filter size of the band division filter.

Thereafter, a processing procedure from step S205 to step S209 is the same as the processing from step S107 to step S111 illustrated in FIG. 11.

As explained above, when the band of the sound signal is divided in the frequency domain, there is an advantage that it is possible to execute the processing according to the characteristics of the sound source while analyzing the characteristics. On the other hand, in the band division for the sound signal in the frequency domain, it is necessary to accumulate samples necessary for analyzing the frequency characteristics. Response speed is not always high. When the band of the sound signal is divided in the time domain, since the processing can be directly executed on a sample of the target sound, there is an advantage that response speed is high. On the other hand, in the band division for the sound signal in the time domain, the characteristics of the target sound are not considered and any sound source is uniformly processed. As explained above, the band division for the sound signal in the frequency domain and the band division for the sound signal in the time domain have different advantages. Therefore, the reproduction device 100 may properly use the band division for the sound signal in the frequency domain and the band division for the sound signal in the time domain according to a situation. For example, each type of reproduction equipment may have a processing form of either the band division in the time domain or the band division in the frequency domain. One type of reproduction equipment may have both forms of the band division processing in the time domain and the band division processing in the frequency domain in combination in a control unit and may be able to freely change a processing form of the band division even while reproducing sound.

### 3. Second Embodiment

### <3-1. System Configuration Example>

In the first embodiment explained above, an example is explained in which the signal processing of inverting the phase of only the sound component of the specific frequency band is executed on the sound source such as the music content, the voice content, or the like stored in advance in the reproduction device 100. For example, in online communication such as an online meeting, when utterances, noises, and the like of other participants overlap an utterance of a certain participant, the signal processing method according to the first embodiment can be applied in the same manner by treating, as noise, a voice signal intervening in an utterance of a preceding speaker.

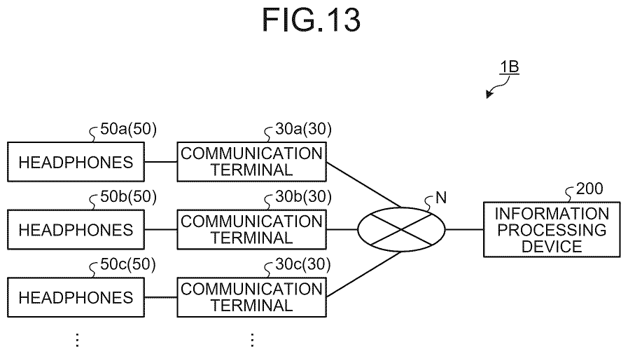

Therefore, in a second embodiment explained below, an example of information processing in the case in which the signal processing method according to the first embodiment is applied to a voice signal exchanged using a communication tool for online communication is explained. First, a configuration of an information processing system 1B according to the second embodiment of the present disclosure is explained with reference to FIG. 13. FIG. 13 is a diagram illustrating a configuration example of the information processing system according to the second embodiment of the present disclosure.

Note that, in the following description, when it is unnecessary to particularly distinguish a communication terminal 30a, a communication terminal 30b, and a communication terminal 30c, the communication terminals are collectively referred to as “communication terminal(s) 30” and explained. Further, in the following explanation, when it is unnecessary to particularly distinguish headphones 50a, headphones 50b, and headphones 50c, the headphones are collectively referred to as “headphones 50”.

As illustrated in FIG. 13, the information processing system 1B according to the second embodiment includes a plurality of pairs of headphones 50, a plurality of communication terminals 30, and an information processing device 200. The communication terminals 30 and the information processing device 200 are connected to the network N by wire or radio. The communication terminals 30 can communicate with other communication terminals 30 and the information processing device 200 through the network N. The information processing device 200 can communicate with the communication terminals 30 through the network N. The headphones 50 are respectively connected to the communication terminals 30 corresponding thereto by wire or radio.

The network N may include a public line network such as the Internet, a telephone line network, or a satellite communication network, various local area networks (LANs) including Ethernet (registered trademark), or a wide area network (WAN). The network N may include a dedicated line network such as an IP-VPN (Internet Protocol-Virtual Private Network). The network N may include a wireless communication network such as Wi-Fi (registered trademark) or Bluetooth (registered trademark).

The communication terminals 30 are information processing terminals used as communication tools for online communication. Users of the communication terminals 30 can, by respectively operating the online communication tools, communicate with other users, who are participants in an event such as an online meeting, through a platform provided by the information processing device 200.

The communication terminal 30 has various functions for implementing online communication. For example, the communication terminal 30 includes a communication device including a modem and an antenna for communicating with the other communication terminals 30 or the information processing device 200 through the network N and a display device including a liquid crystal display and a drive circuit for displaying an image including a still image or a moving image. The communication terminal 30 includes a voice output device such as a speaker that outputs voice and the like of other users in the online communication and a voice input device such as a microphone that inputs voice and the like of the user in the online communication. The communication terminal 30 may include a photographing device such as a digital camera that photographs the user and the surroundings of the user.

The communication terminal 30 is implemented by, for example, a desktop PC (Personal Computer), a notebook PC, a tablet terminal, a smartphone, a PDA (Personal Digital Assistant), or a wearable device such as an HMD (Head Mounted Display).

The communication terminal 30 can output voice and the like of other users in the online communication to the headphones 50 connected thereto. Note that the headphones 50 may be earphones, a hearing aid, a sound collector, or the like and a type of the headphones 50 is not limited. That is, the earphones may be an open ear type or a canal type and the hearing aid may be a CIC (Completely In-The-Canal) type, a BTE (Behind the Ear) type, a RIC (Receiver-In-Canal) type, or the like. The communication terminals 30 and the headphones 50 may be configured as an information processing terminal physically and functionally integrated by a wearable device such as an HMD.

The information processing device 200 is an information processing device that provides, to the users, a platform for implementing online communication. The information processing device 200 is implemented by a server device. The information processing device 200 may be implemented by a single server device or may be implemented by a cloud system in which a plurality of server devices and a plurality of storage devices connected to the network N operate in cooperation with each other.

### <3-2. Device Configuration Example>

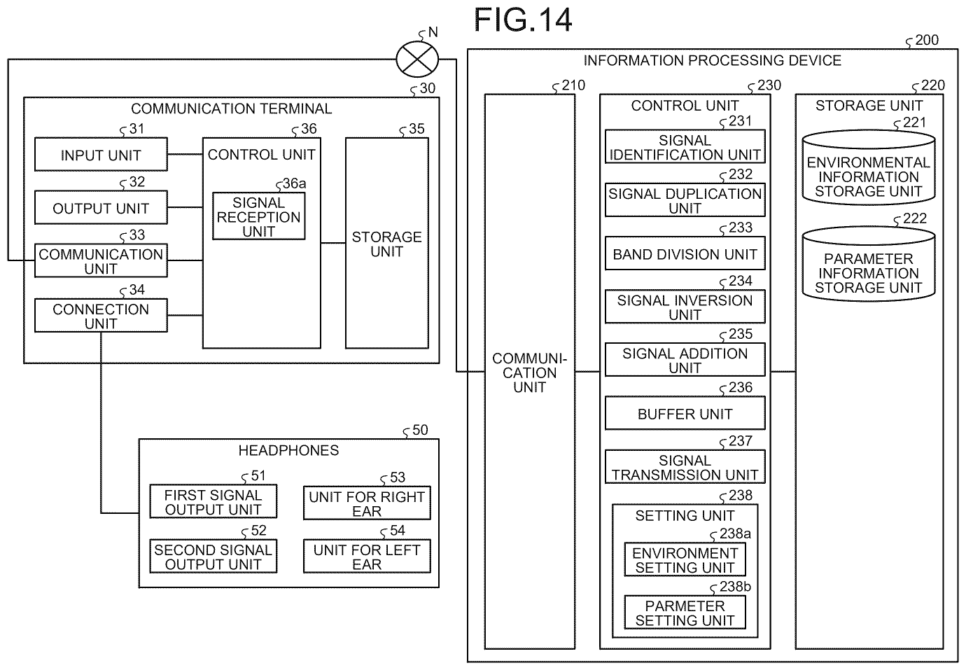

In the following explanation, a device configuration of the devices included in the information processing system 1B according to the second embodiment of the present disclosure is explained with reference to FIG. 14. FIG. 14 is a block diagram illustrating the device configuration example of the devices included in the information processing system according to the second embodiment of the present disclosure.

### (3-2-1. Configuration Example of the Communication Terminal)

As illustrated in FIG. 14, the communication terminal 30 included in the information processing system 1B includes an input unit 31, an output unit 32, a communication unit 33, a connection unit 34, a storage unit 35, and a control unit 36. Note that FIG. 14 illustrates an example of a functional configuration of the communication terminal 30 according to the second embodiment. The communication terminal 30 is not limited to the example illustrated in FIG. 14 and may have another configuration.

The input unit 31 receives various kinds of operation. The input unit 31 is implemented by a mouse and an input device such a keyboard or a touch panel. The input unit 31 includes a voice input device such as a microphone that inputs voice and the like of a user U in the online communication. The input unit 31 may include a photographing device such as a digital camera that photographs the user and the surroundings of the user.

For example, the input unit 31 receives input of initial setting information concerning online communication. The input unit 31 receives a voice input of a user who has uttered during execution of the online communication.

The output unit 32 outputs various kinds of information. The output unit 32 is implemented by an output device such as a display or a speaker. The output unit 32 may be integrally configured to include the headphones 50 and the like connected via the connection unit 34.

For example, the output unit 32 displays a setting window for initial setting concerning online communication. The output unit 32 outputs voice and the like corresponding to a voice signal of the other party user received by the communication unit 33 during execution of the online communication.

The communication unit 33 transmits and receives various kinds of information. The communication unit 33 is implemented by a communication module or the like for transmitting and receiving data to and from other devices such as the other communication terminals 30 and the information processing device 200 by wire or radio. The communication unit 33 communicates with the other devices in a scheme such as a wired LAN (Local Area Network), a wireless LAN, Wi-Fi (registered trademark), infrared communication, Bluetooth (registered trademark), or short range or non-contact communication.

For example, the communication unit 33 receives a voice signal of a communication partner from the information processing device 200 during the execution of the online communication. During the execution of the online communication, the communication unit 33 transmits a voice signal of the user input by the input unit 31 to the information processing device 200.

When the headphones 50 include a communication unit for wirelessly connecting to the communication terminal 30, the communication unit 33 may establish wireless connection with the headphone 50 using a wireless communication protocol such as a wireless LAN, Bluetooth (registered trademark), or a wireless USB (WUSB). When the headphones 50 include a receiver for infrared communication, the communication unit 33 may transmit a voice signal with infrared rays.

The connection unit 34 is connected to other equipment. For example, the connection unit 34 can establish a wired connection such as a USB (Universal Serial Bus), an HDMI (registered trademark) (High-Definition Multimedia Interface), or an MHL (Mobile High-definition Link) with the headphones 50 via a connection terminal (and, if necessary, a cable).

The storage unit 35 is implemented by, for example, a semiconductor memory element such as a RAM (Random Access Memory) or a flash memory or a storage device such as a hard disk or an optical disk. The storage unit 35 can store, for example, programs and data for implementing various processing functions to be executed by the control unit 36. The programs stored by the storage unit 35 include an operating system (OS) and various application programs. For example, the storage unit 35 can store an application program for performing online communication such as an online meeting through a platform provided from the information processing device 200. The storage unit 35 can store information indicating to which of a functional channel and a non-functional channel each of a first signal output unit 51 and a second signal output unit 52 included in the headphones 50 corresponds.

The control unit 36 is implemented by a control circuit including a processor and a memory. Various kinds of processing to be executed by the control unit 36 are implemented by, for example, commands described in programs read from an internal memory by the processor being executed using the internal memory as a work area. The programs read from the internal memory by the processor include an OS (Operating System) and application programs. The control unit 36 may be implemented by an integrated circuit such as an ASIC (Application Specific Integrated Circuit), an FPGA (Field-Programmable Gate Array), or an SoC (System-on-a-Chip).

A main storage device and an auxiliary storage device functioning as the internal memory explained above are implemented by, for example, a semiconductor memory element such as a RAM (Random Access Memory) or a flash memory or a storage device such as a hard disk or an optical disk.

As illustrated in FIG. 14, the control unit 36 includes a signal reception unit 36a. The signal reception unit 36a receives, through the communication unit 33, a voice signal of online communication transmitted from the information processing device 200. When the first signal output unit 51 of the headphone 50 corresponds to a non-functional channel (for example, when “Rch” is functioning as the non-functional channel), the signal reception unit 36a sends a voice signal for the right ear received from the information processing device 200 to the headphones 50 through the non-functional channel. When the second signal output unit 52 corresponds to a functional channel (for example, when “Lch” is functioning as the functional channel), the signal reception unit 36a sends a voice signal for the left ear received from the information processing device 200 to the headphones 50 through the functional channel. Note that, when the communication terminal 30 and the headphone 50 are wirelessly connected, the signal reception unit 36a can transmit a voice signal to the headphones through the communication unit 33.

### (3-2-2. Configuration Example of the Headphones)

As illustrated in FIG. 14, the headphones 50 included in the information processing system 1B include a first signal output unit 51, a second signal output unit 52, a unit for right ear 53, and a unit for left ear 54.

For example, when “Rch” is functioning as a non-functional channel, the first signal output unit 51 sends a voice signal acquired from the communication terminal 30 to the unit for right ear 53 through a path corresponding to the non-functional channel (“Rch”). The unit for right ear 53 reproduces, as sound, the voice signal received from the first signal output unit 51 by changing the voice signal to a motion of a diaphragm and outputs the sound to the outside.

For example, when “Lch” is functioning as a functional channel, the second signal output unit 52 sends the voice signal acquired from the communication terminal 30 to the unit for left ear 54 through a path corresponding to the functional channel (“Lch”). The unit for left ear 54 reproduces, as sound, the voice signal received from the second signal output unit 52 to a motion of a diaphragm and outputs the sound to the outside.

### (3-2-3. Configuration Example of the Information Processing Device)

As illustrated in FIG. 14, the information processing device 200 included in the information processing system 1B includes a communication unit 210, a storage unit 220, and a control unit 230.

The communication unit 210 transmits and receives various kinds of information. The communication unit 210 is implemented by a communication module or the like for transmitting and receiving data to and from other devices such as the communication terminal 30 by wire or radio. The communication unit 210 communicates with the other devices in a scheme such as a wired LAN (Local Area Network), a wireless LAN, Wi-Fi (registered trademark), infrared communication, Bluetooth (registered trademark), or short range or non-contact communication.

For example, the communication unit 210 receives a voice signal transmitted from the communication terminal 30. The communication unit 210 sends the received voice signal to the control unit 230. For example, the communication unit 210 transmits a voice signal generated by the control unit 230 explained below to the communication terminal 30.

The storage unit 220 is implemented by, for example, a semiconductor memory element such as a RAM (Random Access Memory) or a flash memory or a storage device such as a hard disk or an optical disk. The storage unit 220 can store, for example, programs and data for implementing various processing functions executed by the control unit 230. The programs stored in the storage unit 220 include an operating system (OS) and various application programs.

As illustrated in FIG. 14, the storage unit 220 includes an environmental information storage unit 221 and a parameter information storage unit 222.

The environmental information storage unit 221 stores information concerning environment setting set by the user. For example, the information concerning the environment setting stored in the environmental information storage unit 221 includes information concerning a functional channel selected by the user.

The parameter information storage unit 222 stores information concerning parameters for signal processing set by the user. For example, the parameters for signal processing stored in the parameter information storage unit 222 include information indicating a band for dividing, in a sound signal, an inversion frequency band set as a target of phase inversion processing and a non-inversion frequency band not set as a target of the phase inversion processing.

The control unit 230 is implemented by a control circuit including a processor and a memory. Various kinds of processing to be executed by the control unit 230 are implemented by, for example, commands described in programs read from an internal memory by the processor being executed using the internal memory as a work area. The programs read from the internal memory by the processor include an OS (Operating System) and application programs. The control unit 230 may be implemented by an integrated circuit such as an ASIC (Application Specific Integrated Circuit), an FPGA (Field-Programmable Gate Array), or an SoC (System-on-a-Chip).

As illustrated in FIG. 14, the control unit 230 includes a signal identification unit 231, a signal duplication unit 232, a band division unit 233, a signal inversion unit 234, a signal addition unit 235, a buffer unit 236, a signal transmission unit 237, and a setting unit 238. Among these units included in the control unit 230, the signal duplication unit 232, the band division unit 233, the signal inversion unit 234, the signal addition unit 235, the buffer unit 236, and the setting unit 238 configure a signal processing block that provides a function for executing a signal processing method according to the second embodiment. Note that the signal duplication unit 232, the band division unit 233, the signal inversion unit 234, the signal addition unit 235, the buffer unit 236, the signal transmission unit 237, and the setting unit 238 (an environment setting unit 238a and a parameter setting unit 238b) respectively correspond to the signal duplication unit 152, the band division unit 153, the signal inversion unit 154, the signal addition unit 155, the buffer unit 156, the signal transmission unit 157, and the setting unit 158 (the environment setting unit 158a and the parameter setting unit 158b) included in the control unit 150 of the reproduction device 100 according to the first embodiment.

When the signal strength of a first voice signal corresponding to voice of a preceding speaker and the signal strength of a second voice signal corresponding to voice of an intervening speaker exceed a predetermined threshold, the signal identification unit 231 detects an overlapping section in which the first voice signal and the second voice signal are redundantly input. Then, the signal identification unit 231 identifies the first voice signal or the second voice signal as a phase inversion target in the overlapping section.

For example, the signal identification unit 231 refers to information concerning environment setting stored in the environmental information storage unit 221 and identifies, based on an emphasis scheme corresponding to the information, a voice signal set as a phase inversion target. The signal identification unit 231 marks a user linked with the identified voice signal. Accordingly, the signal identification unit 231 identifies, during execution of online communication, a voice signal of a user who can be a target of phase inversion operation out of a plurality of users who are participants in an event such as an online meeting.

For example, when “preceding” emphasizing the voice of the preceding speaker is set as the corresponding emphasis scheme, the signal identification unit 231 marks a user of the voice immediately after voice input sufficient for conversation is started from silence (a signal equal to or smaller than a certain very small threshold or a signal equal to or smaller than a sound pressure that can be recognized as voice) after the start of the online communication. The signal identification unit 231 continues the marking of the voice of the target user until the voice of the target user becomes silent (the signal equal to or smaller than the certain very small threshold or the signal equal to or smaller than the sound pressure that can be recognized as a sound).

The signal identification unit 231 executes overlap detection for detecting voice (intervention sound) equal to or greater than the threshold input from at least one or more other participants during the marked user's utterance (during a marking period). That is, when “preceding” for emphasizing the voice of the preceding speaker is set, the signal identification unit 231 identifies an overlapping section in which a voice signal of the preceding speaker and a voice signal (intervention sound) of the intervening speaker overlap.

When the overlap of the intervention sound is detected while the marking of the voice signal of the target user is continued, the signal identification unit 231 transmits the voice signal acquired from the marked user as a command voice signal and transmits voice signals acquired from the other users as non-command voice signals to the signal processing block in a later stage in two paths.

### (3-2-4. Specific Example of the Units of the Information Processing Device)

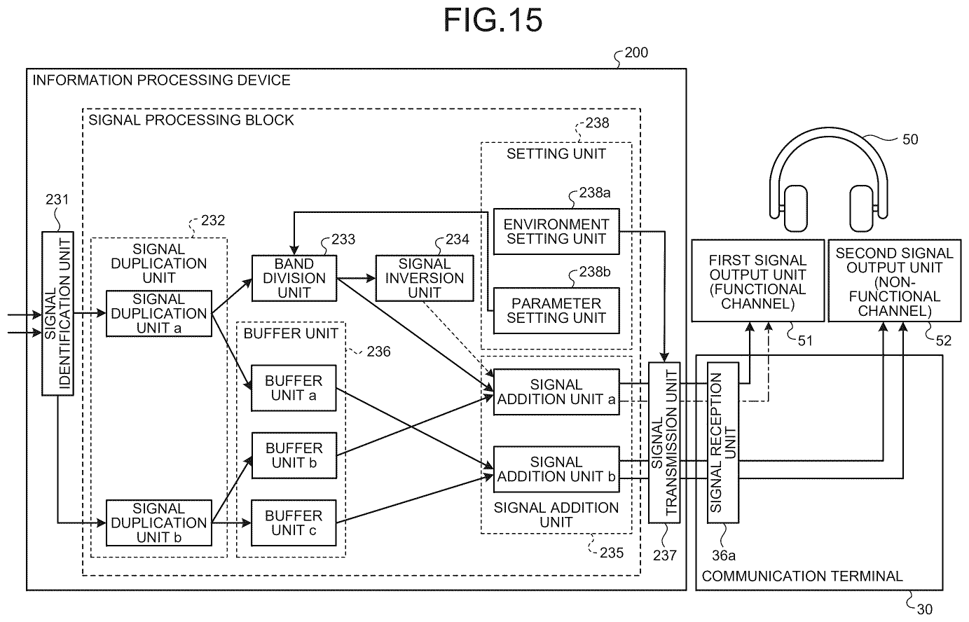

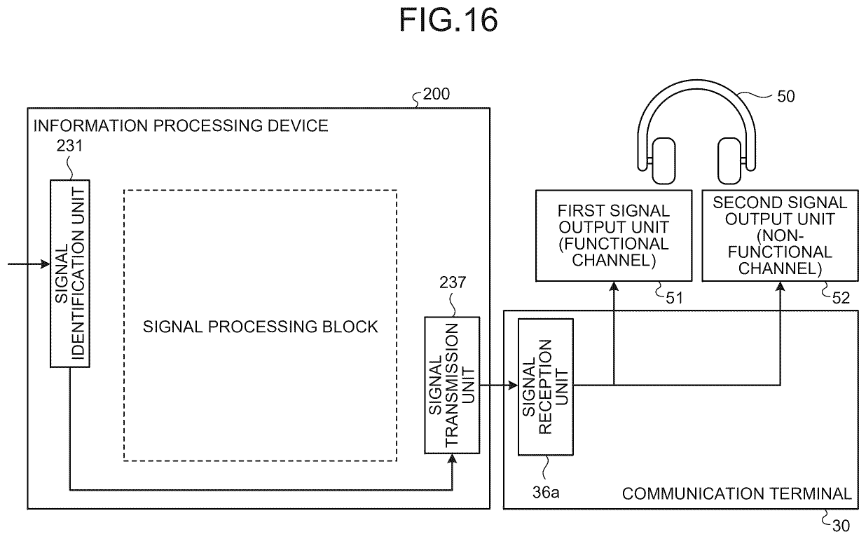

In the following explanation, a specific example of the units of the information processing device according to the second embodiment is explained with reference to the drawings. The specific example of the units of the information processing system is explained. FIG. 15 and FIG. 16 are diagrams for explaining the specific example of the units of the information processing device according to the second embodiment of the present disclosure. Note that, in the following explanation, a specific example of the units in the case in which target sound that imparts the effects of the BMLD to voice of a preceding speaker is set is explained. In the following explanation, it is premised that the target sound is a monophonic signal.

As illustrated in FIG. 15, when preceding voice overlaps intervention sound, the signal identification unit 231 detects overlap (hereinafter referred to as overlap detection), sends the preceding voice to a signal duplication unit a included in the signal duplication unit 232, and sends the intervention sound to a signal duplication unit b included in the signal duplication unit 232. The overlap detection by the signal identification unit 231 is executed according to a processing unit of the signal processing block executed in real time.

As the preceding sound (monophonic signal) received from the signal identification unit 231 is output as a stereo signal, the signal duplication unit a duplicates the preceding sound. Subsequently, the signal duplication unit a sends one of duplicated voice signals to the band division unit 233 and sends the remaining other to a buffer unit a included in the buffer unit 236.

As the intervention sound (monophonic signal) received from the signal identification unit 231 is output as a stereo signal, the signal duplication unit b duplicates the intervention sound. Subsequently, the signal duplication unit b sends one of duplicated voice signals to a buffer unit b included in the buffer unit 236 and sends the remaining other to a buffer unit c included in the buffer unit 236.

The band division unit 233 divides the voice signal received from the signal duplication unit a into a voice signal in an inversion frequency band and a voice signal in a non-inversion frequency band. Then, the band division unit 233 sends the voice signal in the inversion frequency band to the signal inversion unit 234 and sends the voice signal in the non-inversion frequency band to a signal addition unit a included in the signal addition unit 235.

The signal inversion unit 234 executes phase inversion processing of inverting a phase of the voice signal in the inversion frequency band received from the band division unit 233 and sends a generated inverted signal to the signal addition unit a included in the signal addition unit 235.

The buffer unit 236 temporarily stores the voice signal received by each of the buffer unit a, the buffer unit b, and the buffer unit c and waits for sending the voice signal to the signal addition unit 235 until signal processing (phase inversion processing) in the signal inversion unit 234 is completed.

Specifically, the buffer unit a temporarily stores the voice signal received from the signal duplication unit a and puts the voice signal on standby. Then, when detecting completion of the signal processing in the signal inversion unit 234, the buffer unit a transmits the temporarily stored voice signal to a signal addition unit b included in the signal addition unit 235. The buffer unit b temporarily stores the voice signal received from the signal duplication unit b and puts the voice signal on standby. Then, when detecting completion of the signal processing in the signal inversion unit 234, the buffer unit b sends the temporarily stored voice signal to the signal addition unit a. The buffer unit c temporarily stores the sound signal received from the signal duplication unit b and puts the sound signal on standby. Then, when detecting completion of the signal processing in the signal inversion unit 234, the buffer unit c transmits the voice signal to the signal addition unit b.

The signal addition unit a included in the signal addition unit 235 adds up the inverted signal received from the signal inversion unit 234, the voice signal received from the buffer unit b, and the voice signal in the non-inversion frequency band received from the band division unit 233 and sends a voice signal after being added up to the signal transmission unit 237.

The signal addition unit b included in the signal addition unit 235 adds up the voice signal received from the buffer unit a and the voice signal received from the buffer unit c and sends a voice signal after being added up to the signal transmission unit 237.

The signal transmission unit 237 transmits the voice signals for two channels received from the signal addition unit 235 to the communication terminal 30.

As illustrated in FIG. 16, when no overlap of the preceding voice and the intervention sound is detected, the signal identification unit 231 sends the acquired voice signal as it is to signal transmission unit 237.

### <<4. Modifications>>

<4-1. Processing Procedure (Part 1) in the Case in which Target Sound is a Stereo Signal>

When target sound is a stereo signal, effects of the target sound are affected by whether components of sound desired to be listened to is allocated to left and right respective channels in the same degree. The signal processing method according to the first embodiment can exert the effects of the BMLD on sound including similar signal components in each of the left and right channels, for example, voice of a vocalist included in music content.

When the target sound is the stereo signal, the processing by the signal duplication unit 152 among the signal processing blocks (see FIG. 8, FIG. 10, and the like) included in the reproduction device 100 according to the first embodiment is omitted. The signal processing method according to the first embodiment is executed on a sound signal on a channel side designated as a functional channel by the environment setting unit 158a.

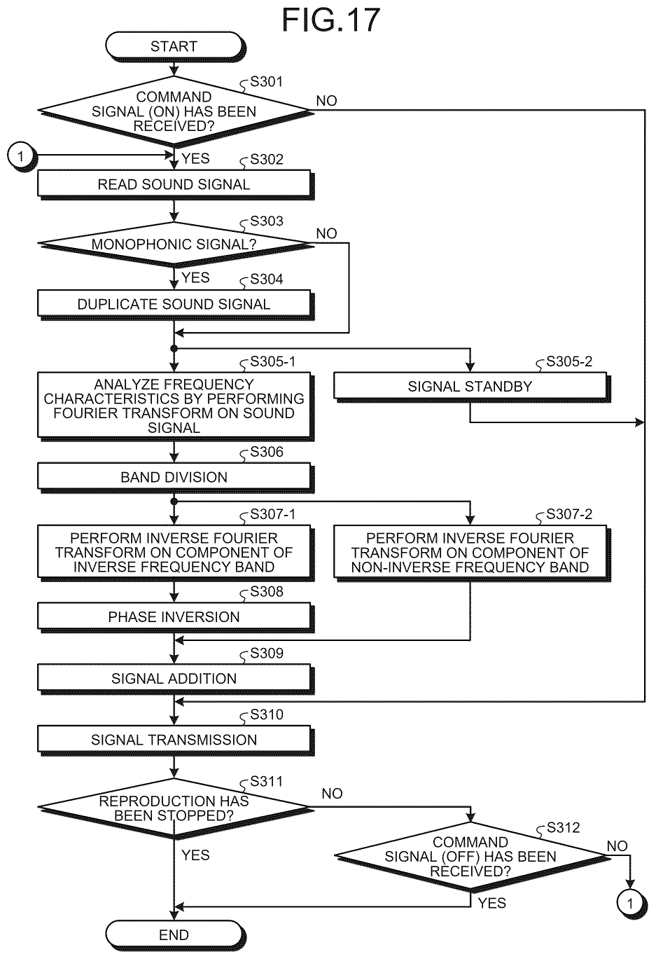

In the following explanation, a processing procedure (part 1) by the reproduction device 100 in the case in which the target sound is the stereo signal is explained with reference to FIG. 17. FIG. 17 is a flowchart illustrating an example of a processing procedure (part 1) of a reproduction device according to a modification of the present disclosure. FIG. 17 illustrates an example of a processing procedure in the case in which a band of a sound signal is divided in a frequency domain. The processing procedure illustrated in FIG. 17 is different from the processing procedure by the reproduction device according to the first embodiment (see FIG. 11) in that a processing procedure in step S303 corresponding to the case in which the target sound is the stereo signal is added. In the following explanation, differences from the processing procedure according to the first embodiment is explained.

The execution command unit 151 determines whether the target sound is a monophonic signal (step S303). When the execution command unit 151 determines that the target sound is a monophonic signal (step S303; Yes), the signal duplication unit 152 duplicates the sound signal (step S304).

On the other hand, when determining that the target sound is not a monophonic signal (step S303; No), the execution command unit 151 sends a sound signal on a functional channel side of sound signals to the band division unit 153 and sends a sound signal on a non-functional channel side to the buffer unit 156.

<4-2. Processing Procedure (Part 2) in the Case in which the Target Sound is the Stereo Signal>

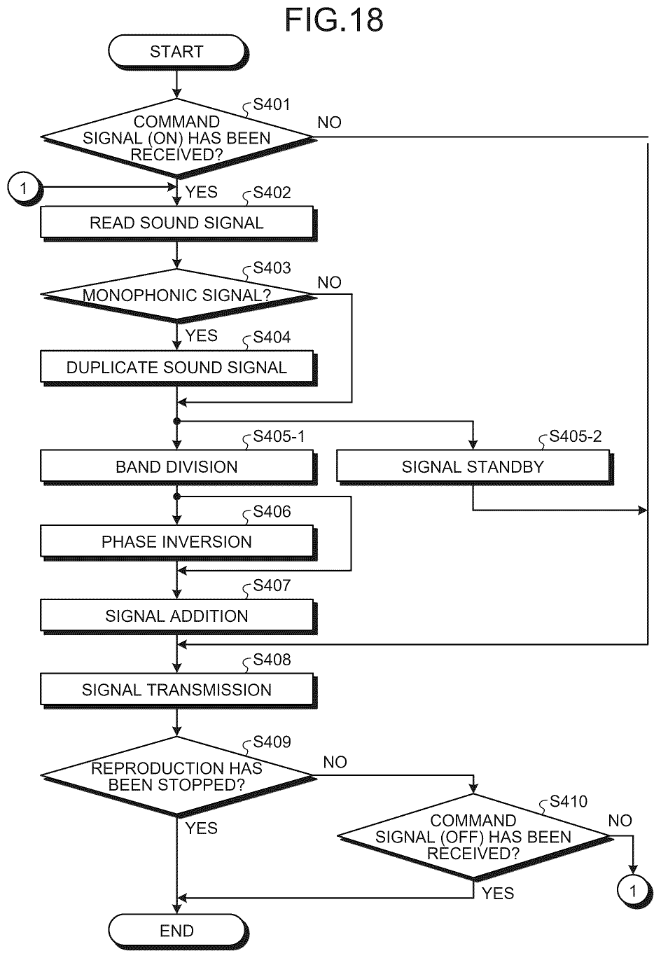

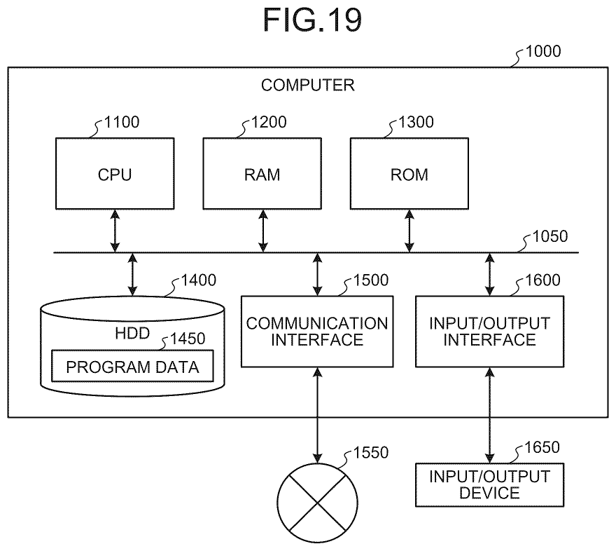

In the following explanation, a processing procedure (part 2) by the reproduction device 100 in the case in which the target sound is the stereo signal is explained with reference to FIG. 18. FIG. 18 is a flowchart illustrating an example of a processing procedure (part 2) of the reproduction device according to a modification of the present disclosure. The processing procedure illustrated in FIG. 18 is different from the processing procedure by the reproduction device according to the first embodiment (see FIG. 12) in that a processing procedure in step S403 corresponding to the case in which the target sound is the stereo signal is added. In the following explanation, differences from the processing procedure according to the first embodiment is explained.

The execution command unit 151 determines whether the target sound is a monophonic signal (step S403). When the execution command unit 151 determines that the target sound is a monophonic signal (step S403; Yes), the signal duplication unit 152 duplicates the sound signal (step S404).

On the other hand, when determining that the target sound is not a monophonic signal (step S403; No), the execution command unit 151 sends a sound signal on a functional channel side of sound signals to the band division unit 153 and sends a sound signal on a non-functional channel side to the buffer unit 156.

### <<5. Others>>

Various programs for implementing the signal processing method (see, for example, FIG. 11 and FIG. 12) executed by the reproduction device 100 according to the first embodiment explained above may be distributed by being stored in a computer-readable recording medium or the like such as an optical disk, a semiconductor memory, a magnetic tape, or a flexible disk. At this time, the reproduction device 100 according to the first embodiment can implement the signal processing method (an information processing method) according to the first embodiment of the present disclosure by installing the various programs in a computer and executing the various programs. Various programs for implementing the signal processing method (see, for example, FIG. 15 and FIG. 16) and the like executed by the information processing device 200 according to the second embodiment may be distributed by being stored in a computer-readable recording medium or the like such as an optical disk, a semiconductor memory, a magnetic tape, or a flexible disk. At this time, the information processing device 200 according to the second embodiment can implement the signal processing method (an information processing method) according to the second embodiment of the present disclosure by installing the various programs in a computer and executing the various programs.

The various programs for implementing the signal processing method (see, for example, FIG. 11 and FIG. 12) executed by the reproduction device 100 according to the first embodiment may be stored in a disk device included in a server on a network such as the Internet and made available for downloading to a computer. The various programs for implementing the signal processing method (see, for example, FIG. 15 and FIG. 16) executed by the information processing device 200 according to the second embodiment may be stored in a disk device included in a server on a network such as the Internet and made available for downloading to a computer. Functions provided by the various programs for implementing the signal processing methods (the information processing methods) according to the embodiments explained above may be implemented by cooperation of an OS and application program. In this case, a portion other than the OS may be stored in a medium and distributed or the portion other than the OS may be stored in an application server and made available for downloading to a computer.

Among the kinds of processing explained in the embodiments and the modification explained above, all or a part of the processing explained as being automatically performed can be manually performed or all or a part of the processing explained as being manually performed can be automatically performed by a publicly known method. Besides, the processing procedures, the specific names, and the information including the various data and parameters explained in the above document and illustrated in the drawings can be optionally changed except when specifically noted otherwise. For example, the various kinds of information illustrated in the figures are not limited to the illustrated information.

The components of the reproduction device 100 according to the first embodiment explained above are functionally conceptual and is not always required to be configured as illustrated. For example, the units of the control unit 150 included in the reproduction device 100 may be functionally integrated in any unit or may be distributed. The components of the information processing device 200 according to the second embodiment explained above are functionally conceptual and are not always required to be configured as illustrated. For example, the units of the control unit 230 included in the information processing device 200 may be functionally integrated in any unit or may be distributed.

The embodiments and the modifications of the present disclosure can be combined as appropriate in a range in which processing contents do not contradict. The order of the steps illustrated in the flowcharts according to the embodiments and the modifications of the present disclosure can be changed as appropriate.

Although the embodiments and the modifications of the present disclosure are explained above, the technical scope of the present disclosure is not limited to the embodiments and the modifications explained above, and various changes can be made without departing from the gist of the present disclosure. Components in different embodiments and modifications may be combined as appropriate.

### <<7. Conclusion>>

For example, the reproduction device 100 according to the first embodiment of the present disclosure includes the signal duplication unit 152, the band division unit 153, the signal inversion unit 154, the signal addition unit 155, the buffer unit 156, and the signal transmission unit 157. The signal duplication unit 152 duplicates target sound set as a processing target. The band division unit 153 divides a band of the target sound into an inversion frequency band set as a target of phase inversion processing and a non-inversion frequency band not set as a target of the phase inversion processing. The signal inversion unit 154 generates an inverted signal obtained by inverting a phase of a first sound signal corresponding to the inversion frequency band. The signal addition unit 155 generates an addition signal obtained by adding up the inverted signal and a second sound signal corresponding to the non-inversion frequency band. The buffer unit 156 temporarily stores an original sound signal before processing. The signal transmission unit 157 transmits the addition signal and the original sound signal stored in the buffer unit 156 to external equipment (for example, the sound output device 10) while synchronizing the addition signal and the original sound signal. In this way, the reproduction device 100 according to the first embodiment of the present disclosure executes signal processing for phase-inverting only a sound component in a specific frequency band in the target sounds to thereby be able to solve a problem in listener's audibility that can occur when processing of a BMLD has been executed and give natural audibility to the listener.

In addition, the band division unit 153 divides the band of the target sound according to a boundary value set in order to divide the inversion frequency band and the non-inversion frequency band.

The band division unit 153 divides the band of the target sound according to a boundary value set based on the characteristic of the target sound or the characteristic of the environmental noise.

The band division unit divides the band of the target sound according to a boundary value set based on auditory characteristics of the user.

In this way, the reproduction device 100 can appropriately divide the band of the target sound.

The reproduction device 100 further includes the parameter setting unit 158b that receives the setting of the boundary value from the user. Then, the band division unit 153 divides the band of the target sound according to the boundary value set by the user. In this way, the reproduction device 100 can divide the band of the target sound according to a request of the user.

The parameter setting unit 158b presents information concerning a recommended value recommended as the boundary value to the user based on an analysis result of frequency characteristics of the target sound. In this way, the reproduction device 100 can assist setting operation by the user. The boundary value can take any value.

The band division unit 153 divides the band of the target sound in a frequency domain based on the analysis result of the frequency characteristics of the target sound. In this way, the reproduction device 100 can execute signal processing based on an inversion frequency band matching characteristics of the target sound.

The band division unit 153 divides the band of the target sound in the frequency domain or a time domain. In this way, the reproduction device 100 can execute, according to a situation, signal processing that prioritizes responsiveness of processing.

The reproduction device 100 further includes the execution command unit 151 that receives an execution command for signal processing transmitted from external equipment (for example, the sound output device 10) on condition that a sound pressure level of noise exceeds a predetermined threshold. The execution command unit 151 starts signal processing of partially inverting the phase of the target sound at the opportunity when the execution command is received. In this way, the reproduction device 100 can make it easy to listen to the target sound even in a noise environment.

The information processing device 200 according to the second embodiment can also give natural audibility to the listener in online communication and, like the reproduction device 100, can support the listener such that smooth communication is implemented.

Note that the effects described in the present specification are only illustrative or exemplary and are not restrictive. That is, the technique of the present disclosure can achieve, together with or instead of the effects explained above, other effects obvious for those skilled in the art from the description of the present specification.

Note that the technique of the present disclosure can also take the following configurations as configurations belonging to the technical scope of the present disclosure.

(1)

An information processing device comprising:
a signal duplication unit that duplicates a sound signal of target sound set as a processing target;
a band division unit that divides a band of the target sound into an inversion frequency band set as a target of phase inversion processing and a non-inversion frequency band not set as a target of the phase inversion processing;
a signal inversion unit that generates an inverted signal obtained by inverting a phase of a first sound signal corresponding to the inversion frequency band;
a signal addition unit that generates an addition signal obtained by adding up the inverted signal and a second sound signal corresponding to the non-inversion frequency band;
a buffer unit that temporarily stores an original sound signal of the target sound before processing; and
a signal transmission unit that transmits the addition signal and the original sound signal stored in the buffer unit to external equipment while synchronizing the addition signal and the original sound signal.
   (2)

The information processing device according to (1), wherein
the band division unit
divides the band of the target sound according to a boundary value set in order to divide the inversion frequency band and the non-inversion frequency band.
   (3)

The information processing device according to (2), wherein
the band division unit
divides the band of the target sound according to the boundary value set based on characteristics of the target sound or characteristics of environmental noise.
   (4)

The information processing device according to (2), wherein
the band division unit
divides the band of the target sound according to the boundary value set based on auditory characteristics of a user.
   (5)

The information processing device according to (2), further comprising
a parameter setting unit that receives the setting of the boundary value from a user, wherein
the band division unit
divides the band of the target sound according to the boundary value set by the user.
   (6)

The information processing device according to (5), wherein
the parameter setting unit
presents information concerning a recommended value recommended as the boundary value to the user based on an analysis result of frequency characteristics of the target sound.
   (7)

The information processing device according to (6), wherein
the band division unit
divides the band of the target sound in a frequency domain based on an analysis result of frequency characteristics of the target sound.
   (8)

The information processing device according to (2), wherein
the band division unit
divides the band of the target sound in a frequency domain or a time domain.
   (9)

The information processing device according to (1), further comprising
an execution command unit that receives an execution command for signal processing transmitted from the external equipment on condition that a sound pressure level of noise exceeds a predetermined threshold, wherein
the execution command unit
starts the signal processing of partially inverting a phase of the target sound at an opportunity when the execution command is received.
   (10)

An information processing method executed by a computer, the method comprising:
duplicating a sound signal of target sound set as a processing target;
dividing a band of the target sound into an inversion frequency band set as a target of phase inversion processing and a non-inversion frequency band not set as a target of the phase inversion processing;
generating an inverted signal obtained by inverting a phase of a first sound signal corresponding to the inversion frequency band;
generating an addition signal obtained by adding up the inverted signal and a second sound signal corresponding to the non-inversion frequency band;
temporarily storing an original sound signal of the target sound before processing; and
transmitting the addition signal and the original sound signal to external equipment while synchronizing the addition signal and the original sound signal.
   (11)

An information processing program product including information processing program
for causing a computer to function as a control unit that:
duplicates a sound signal of target sound set as a processing target;
divides a band of the target sound into an inversion frequency band set as a target of phase inversion processing and a non-inversion frequency band not set as a target of the phase inversion processing;
generates an inverted signal obtained by inverting a phase of a first sound signal corresponding to the inversion frequency band;
generates an addition signal obtained by adding up the inverted signal and a second sound signal corresponding to the non-inversion frequency band;
temporarily stores an original sound signal of the target sound before processing; and
transmits the addition signal and the original sound signal to external equipment while synchronizing the addition signal and the original sound signal.
   (12)

An information processing system comprising:
a signal duplication unit that duplicates a sound signal of target sound set as a processing target;
a band division unit that divides a band of the target sound into an inversion frequency band set as a target of phase inversion processing and a non-inversion frequency band not set as a target of the phase inversion processing;
a signal inversion unit that generates an inverted signal obtained by inverting a phase of a first sound signal corresponding to the inversion frequency band;
a signal addition unit that generates an addition signal obtained by adding up the inverted signal and a second sound signal corresponding to the non-inversion frequency band;
a buffer unit that temporarily stores an original sound signal of the target sound before processing; and
a signal transmission unit that transmits the addition signal and the original sound signal stored in the buffer unit to external equipment while synchronizing the addition signal and the original sound signal.

### REFERENCE SIGNS LIST

1A, 1B INFORMATION PROCESSING SYSTEM
10 SOUND OUTPUT DEVICE
11 INPUT UNIT
12 OUTPUT UNIT
13 COMMUNICATION UNIT
14 STORAGE UNIT
15 CONTROL UNIT
15a NOISE DETECTION UNIT
15b SIGNAL RECEPTION UNIT
15c FIRST SIGNAL OUTPUT UNIT
15d SECOND SIGNAL OUTPUT UNIT
30 COMMUNICATION TERMINAL
31 INPUT UNIT
32 OUTPUT UNIT
33 COMMUNICATION UNIT
34 CONNECTION UNIT
35 STORAGE UNIT
36 CONTROL UNIT
36a SIGNAL RECEPTION UNIT
50 HEADPHONE
51 FIRST SIGNAL OUTPUT UNIT
52 SECOND SIGNAL OUTPUT UNIT
53 UNIT FOR RIGHT EAR
54 UNIT FOR LEFT EAR
100 REPRODUCTION DEVICE
110 INPUT UNIT
120 OUTPUT UNIT
130 COMMUNICATION UNIT
140 STORAGE UNIT
141 ENVIRONMENTAL INFORMATION STORAGE UNIT
142 PARAMETER INFORMATION STORAGE UNIT
143 CONTENT STORAGE UNIT
150 CONTROL UNIT
151 EXECUTION COMMAND UNIT
152 SIGNAL DUPLICATION UNIT
153 BAND DIVISION UNIT
154 SIGNAL INVERSION UNIT
155 SIGNAL ADDITION UNIT
156 BUFFER UNIT
157 SIGNAL TRANSMISSION UNIT
158 SETTING UNIT
158a ENVIRONMENT SETTING UNIT
158b PARAMETER SETTING UNIT
200 INFORMATION PROCESSING DEVICE
210 COMMUNICATION UNIT
220 STORAGE UNIT
221 ENVIRONMENTAL INFORMATION STORAGE UNIT
222 PARAMETER INFORMATION STORAGE UNIT
230 CONTROL UNIT
231 SIGNAL IDENTIFICATION UNIT
232 SIGNAL DUPLICATION UNIT
233 BAND DIVISION UNIT
234 SIGNAL INVERSION UNIT
235 SIGNAL ADDITION UNIT
236 BUFFER UNIT
237 SIGNAL TRANSMISSION UNIT
238 SETTING UNIT
238a ENVIRONMENT SETTING UNIT
238b PARAMETER SETTING UNIT

1. An information processing device comprising:
a signal duplication unit that duplicates a sound signal of target sound set as a processing target;
a band division unit that divides a band of the target sound into an inversion frequency band set as a target of phase inversion processing and a non-inversion frequency band not set as a target of the phase inversion processing;
a signal inversion unit that generates an inverted signal obtained by inverting a phase of a first sound signal corresponding to the inversion frequency band;
a signal addition unit that generates an addition signal obtained by adding up the inverted signal and a second sound signal corresponding to the non-inversion frequency band;
a buffer unit that temporarily stores an original sound signal of the target sound before processing; and
a signal transmission unit that transmits the addition signal and the original sound signal stored in the buffer unit to external equipment while synchronizing the addition signal and the original sound signal.

2. The information processing device according to claim 1, wherein
the band division unit
divides the band of the target sound according to a boundary value set in order to divide the inversion frequency band and the non-inversion frequency band.

3. The information processing device according to claim 2, wherein
the band division unit
divides the band of the target sound according to the boundary value set based on characteristics of the target sound or characteristics of environmental noise.

4. The information processing device according to claim 2, wherein
the band division unit
divides the band of the target sound according to the boundary value set based on auditory characteristics of a user.

5. The information processing device according to claim 2, further comprising
a parameter setting unit that receives the setting of the boundary value from a user, wherein
the band division unit
divides the band of the target sound according to the boundary value set by the user.

6. The information processing device according to claim 5, wherein
the parameter setting unit
presents information concerning a recommended value recommended as the boundary value to the user based on an analysis result of frequency characteristics of the target sound.

7. The information processing device according to claim 2, wherein
the band division unit
divides the band of the target sound in a frequency domain based on an analysis result of frequency characteristics of the target sound.

8. The information processing device according to claim 2, wherein
the band division unit
divides the band of the target sound in a frequency domain or a time domain.

9. The information processing device according to claim 1, further comprising
an execution command unit that receives an execution command for signal processing transmitted from the external equipment on condition that a sound pressure level of noise exceeds a predetermined threshold, wherein
the execution command unit
starts the signal processing of partially inverting a phase of the target sound at an opportunity when the execution command is received.

10. An information processing method executed by a computer, the method comprising:
duplicating a sound signal of target sound set as a processing target;
dividing a band of the target sound into an inversion frequency band set as a target of phase inversion processing and a non-inversion frequency band not set as a target of the phase inversion processing;
generating an inverted signal obtained by inverting a phase of a first sound signal corresponding to the inversion frequency band;
generating an addition signal obtained by adding up the inverted signal and a second sound signal corresponding to the non-inversion frequency band;
temporarily storing an original sound signal of the target sound before processing; and
transmitting the addition signal and the original sound signal to external equipment while synchronizing the addition signal and the original sound signal.

11. An information processing program product including information processing program
for causing a computer to function as a control unit that:
duplicates a sound signal of target sound set as a processing target;
divides a band of the target sound into an inversion frequency band set as a target of phase inversion processing and a non-inversion frequency band not set as a target of the phase inversion processing;
generates an inverted signal obtained by inverting a phase of a first sound signal corresponding to the inversion frequency band;
generates an addition signal obtained by adding up the inverted signal and a second sound signal corresponding to the non-inversion frequency band;
temporarily stores an original sound signal of the target sound before processing; and
transmits the addition signal and the original sound signal to external equipment while synchronizing the addition signal and the original sound signal.

12. An information processing system comprising:
a signal duplication unit that duplicates a sound signal of target sound set as a processing target;
a band division unit that divides a band of the target sound into an inversion frequency band set as a target of phase inversion processing and a non-inversion frequency band not set as a target of the phase inversion processing;
a signal inversion unit that generates an inverted signal obtained by inverting a phase of a first sound signal corresponding to the inversion frequency band;
a signal addition unit that generates an addition signal obtained by adding up the inverted signal and a second sound signal corresponding to the non-inversion frequency band;
a buffer unit that temporarily stores an original sound signal of the target sound before processing; and
a signal transmission unit that transmits the addition signal and the original sound signal stored in the buffer unit to external equipment while synchronizing the addition signal and the original sound signal.
